(19) United States
(12) Patent Application Publication
(10) Pub. No.: US 2024/0369735 A1
(43) Pub. Date: Nov. 7, 2024

(54) APPARATUS FOR FINE-SCALE, IN-SITU MEASUREMENTS OF TURBULENCE IN THE ATMOSPHERE

(71) Applicant: The Regents of the University of Colorado, a body corporate, Denver, CO (US)

(72) Inventor: Dale A. Lawrence, Louisville, CO (US)

(73) Assignee: The Regents of the University of Colorado, a body corporate, Denver, CO (US)

(21) Appl. No.: 18/655,125

(22) Filed: May 3, 2024

Related U.S. Application Data
(60) Provisional application No. 63/463,835, filed on May 3, 2023.

(51) Int. Cl. G01W 1/06; G01W 1/00; G01W 1/08

(52) U.S. Cl. CPC G01W 1/06; G01W 1/08; G01W 2001/003

(57) ABSTRACT

A system for fine-scale, in-situ measurements of turbulence in the atmosphere is described. The system may be a balloon-borne instrument, performing measurements during slow descents from stratospheric altitudes, and may include at least some of onboard data compression, telemetry of data to a ground station, self-calibration, and data processing to extract turbulence parameters.

### REFERENCE TO RELATED APPLICATIONS

The present application claims the benefit of U.S. Provisional Patent App. No. 63/463,835, filed 2023 May 3 and titled “Apparatus for Fine-Scale, In-Situ Measurements of Turbulence in the Atmosphere,” which is incorporated herein by its entirety by reference.

### SPONSORED RESEARCH AND DEVELOPMENT

This invention was made with government support under FA9550-18-1-0009 awarded by the Air Force Research Laboratory. The government has certain rights in the invention.

### FIELD OF THE INVENTION

The present invention relates to atmospheric measurements. In particular, but not by way of limitation, the present invention relates to systems and methods for performing in-situ measurements of atmospheric turbulence.

### DESCRIPTION OF RELATED ART

An understanding of stratospheric turbulence is critical for accurately predicting the aerothermodynamics of hypersonic vehicles, which are fast becoming a reality in the present age. For example, the experimental X-51A Waverider is an unmanned, autonomous supersonic combustion ramjet-powered hypersonic flight test demonstrator for the U.S. Air Force.

The engine for the X-51A is designed for airspeeds above Mach 6 and above 70,000-ft (21-km) altitude. The final of four test flights of the vehicle was completed on 1 May 2013, with the vehicle reaching an airspeed of approximately Mach 5.1, with a record-setting 210 seconds of airbreathing hypersonic flight. At 80,000 ft (24 km) and Mach 5.1, atmospheric disturbance frequencies of 10 kHz to 1000 kHz correspond to spatial scales of 15 cm to 1.5 mm, respectively, and at Mach 7 and 24 km, the same disturbance frequency range corresponds to spatial scales of 21 cm to 2.1 mm.

It would be desirable to better understand the implications of turbulence at such spatiotemporal and disturbance frequency scales, particularly in developing vehicles for hypersonic flight. In addition, better understanding of the conditions leading to clear-air turbulence would benefit commercial air transportation as well as military applications in flight above the troposphere.

To this effect, it would be desirable to conduct extensive, geographically distributed measurements of in-situ turbulence and background winds above the tropopause altitude (about 13 km) and acquire measurements under normal and very strong meteorological forcing conditions.

### SUMMARY OF THE INVENTION

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

In embodiments, a system for measurement of turbulence in the atmosphere ins capable of post-calibration and/or self-calibration of fine wire sensors. In certain embodiments, the present disclosure describes methods of post- and self-calibration for use in turbulence measurements. In certain embodiments, the measurement system for turbulence measurements includes remote data transfer capabilities so that the system could be sent to capture data in the air, transfer the data to the ground, without a need for recovery of the system following measurements.

In an embodiment, a system for measurement of turbulence in the atmosphere includes a hotwire sensor, a coldwire sensor, and a gondola containing electronics including a microprocessor. The gondola includes a first surface and a support structure protruding from the first surface, the support structure being configured for supporting the hotwire sensor and the cold wire sensor at a fixed orientation with respect to each other. In embodiments, the electronics are configured to implement a self-calibration procedure.

In embodiments, the system further includes telemetry antennas.

In embodiments, the hotwire sensor is a turbulence anemometer.

In embodiments, the coldwire sensor is a turbulence thermometer.

In embodiments, the system further includes a balloon for transporting the hotwire sensor, the coldwire sensor, and the gondola into a desired altitude.

In certain embodiments, a system for fine-scale, in-situ measurements of turbulence in the atmosphere includes a balloon-borne instrument. In embodiments, the balloon-borne instrument includes a hotwire anemometer, a coldwire thermometer, a gondola containing electronics, a support structure affixed to the gondola for supporting the hotwire anemometer and the coldwire thermometer at a fixed distance from the gondola, and a balloon for transporting the gondola to a desired altitude. In embodiments, the hotwire anemometer and the coldwire thermometer are configured for performing measurements during descent from the desired altitude to generate measurement data. In embodiments, the electronics includes circuitry for analyzing the measurement data during flight to produce analyzed data and transmitting the analyzed data to a ground station remotely located from the system. In certain embodiments, the electronics are further configured for self-calibrating the analyzed data according to the measurement data.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF DRAWINGS

FIG. 1 illustrates perspective view of an exemplary system for in situ measurement of turbulence in the atmosphere, according to embodiments.

FIG. 2 illustrates a turbulence instrument probe tip for hotwire anemometry and coldwire thermometry, in accordance with an embodiment.

FIG. 3 shows a graph of balloon altitude as a function of elapsed time, in accordance with an embodiment.

FIG. 4 shows a graph of the temperature profile across a wire according to Eq. 25 and finite element simulations with uniform and parabolic velocity profiles, in accordance with certain embodiments.

FIG. 5 shows a graph of the difference in average temperature rise between the numerical and analytical solutions over a range of altitudes, in accordance with an embodiment.

FIG. 6 shows a graph of the difference between the bulk wire thermal conductance results between the numerical and analytical solutions over a range of altitudes, in accordance with an embodiment.

FIG. 7 shows an exemplary geometry of the gondola and the fine wires used for the computational fluid dynamics (CFD) model of flow around the fine wire prongs, in accordance with certain embodiments.

FIG. 8 shows a graph of the velocity magnitude along the wire at various altitude conditions, in accordance with embodiments, as calculated using a CFD model.

FIG. 9 shows a graph of the velocity correction factor as a function of altitude as calculated using a CFD model, in accordance with certain embodiments.

FIG. 10 shows a graph of the velocity correction factor as a function of free-stream velocity as calculated using a CFD model, in accordance with certain embodiments.

FIG. 11 illustrates an exemplary timing scheme suitable for use with the turbulence measurement system, in accordance with embodiments.

FIG. 12 is a circuit schematic of an exemplary Wheatstone bridge configuration suitable for use with the turbulence measurement system, in accordance with embodiments.

FIG. 13 is a block diagram of an implementation of the instrument analog electronics suitable for use with the turbulence measurement system, in accordance with embodiments.

FIGS. 14A and 14B are graphs of typical hotwire instrument frequency response in terms of the magnitude and phase, respectively, as a function of frequency, in accordance with embodiments.

FIGS. 15A and 15B are graphs of typical coldwire instrument frequency response in terms of the magnitude and phase, respectively, as a function of frequency, in accordance with embodiments.

FIG. 16 shows a block diagram of an implementation of a self-calibration process, in accordance with an embodiment.

FIG. 17 shows a block diagram and exemplary outputs of a self-calibration process, in accordance with an embodiment.

FIG. 18 shows a pipelined software architecture suitable for use with the turbulence measurement system, in accordance with certain embodiments.

For simplicity and clarity of illustration, the drawing figures illustrate the general manner of construction, and descriptions and details of well-known features and techniques may be omitted to avoid unnecessarily obscuring the embodiments detailed herein. Additionally, elements in the drawing figures are not necessarily drawn to scale. For example, the dimensions of some of the elements in the figures may be exaggerated relative to other elements to help improve understanding of the described embodiments. The same reference numerals in different figures denote the same elements.

The word “exemplary” is used herein to mean “serving as an example, instance, or illustration.” Any embodiment described herein as “exemplary” is not necessarily to be construed as preferred or advantageous over other embodiments. In the following detailed description, references are made to the accompanying drawings that form a part hereof, and in which are shown by way of illustrations or specific examples. These aspects may be combined, other aspects may be utilized, and structural changes may be made without departing from the present disclosure. Example aspects may be practiced as methods, systems, or apparatuses. The following detailed description is therefore not to be taken in a limiting sense, and the scope of the present disclosure is defined by the appended claims and their equivalents

### DETAILED DESCRIPTION OF THE INVENTION

A primary source of stratospheric turbulence is breaking gravity waves that are caused by strong meteorological forcing events in the lower atmosphere. For instance, convective storms often originate near the foothills of the Rocky Mountains and travel eastward into the Great Plains region of the United States. Consequently, balloons launched from the foothills region will often drift eastward and can pass over convective storms, allowing measurements to be made of the gravity waves caused by such storms. Additionally, mountain waves are caused by strong low-level winds passing over high terrain such as the Rocky Mountains. Balloons launched from west of the Rocky Mountain Continental Divide drift eastward over the mountain peaks and can acquire measurements of the gravity waves and resulting stratospheric turbulence. A third source of turbulence in the stratosphere is jet stream shear that can occur over wide regions in the continental US. High-shear events can be predicted from global forecast system wind models and used to choose balloon launch locations and times to characterize resulting turbulence.

The present disclosure describes systems and methods for performing atmospheric measurements. In particular, the atmospheric measurements include characterization of laminar flow conditions, specifically atmospheric turbulence that may disturb the normal laminar conditions, which results in turbulence in the boundary layer around vehicles (such as hypersonic vehicles) that can greatly affect heat transfer to the vehicle, increase drag, disrupt flow into engines, and reduce effectiveness of control surfaces.

In embodiments, a system for fine-scale, in-situ measurements of turbulence in the atmosphere may be a balloon-borne instrument, performing measurements during slow descents from stratospheric altitudes, and may include at least some of onboard data compression, telemetry of data to a ground station, self-calibration, and processing to extract turbulence parameters. As an example, the system includes one or more fine-wire anemometers with hardware, software, telemetry, and flight operations to enable widespread, high-cadence, high-resolution, in-situ turbulence observations. In embodiments, the present disclosure provides hardware and associated methods to calibrate the fine-wire voltage measurements during flight such that estimates of data, such as turbulent kinetic energy dissipation rate and temperature structure parameter, may be retrieved remotely via telemetry. For instance, such calibration may include a “chopping” technique to periodically change the wire excitation levels in flight, thus providing data that can be used in post-flight procedures to estimate local thermal conductance and fine-wire temperatures needed to self-calibrate for wire sensitivity to velocity and temperature fluctuations. Embodiments of such self-calibration procedures are described in detail below.

In certain embodiments, the system enables low cost, routine access to 10 to 35 kilometer altitudes, with low air speed (e.g., approximately 2 meters/second) and no-wake measurements. Some embodiments include weather balloons with measurements performed on descent using a simple, single balloon vented approach, thus reducing the required number of ground crew members for launch. Some embodiments include special-purpose antennas to enable long distance radio telemetry with expendable payloads in the same cost class as radiosondes, thus removing the requirement to recover the payload upon landing.

In embodiments, the system includes fast response velocity and temperature sensors at low pressure for ˜1 cm turbulence scale size measurements. Some embodiments incorporate fine wire-based hotwire anemometry and coldwire thermometry such as technologies developed for unmanned aerial vehicles (UAVs), thus enabling low cost and low weight sensing implementation. Further, certain embodiments include additional hardware and software technologies, such as self-calibration and onboard data compression, to enable further reduction in cost without sacrificing performance over the wide range of air density and temperature encountered in high-altitude applications.

In embodiments, the system described herein is capable of operating in the stratosphere, such as between 10 kilometers and 35 kilometers in altitude. Certain embodiments include a balloon-borne instrument for fine-scale, in-situ measurements of turbulence in the atmosphere, using slow descents from altitudes up to 35 km, on-board data compression, and telemetry of data to a ground station, together with methods for data calibration and processing to extract turbulence parameters.

In certain embodiments, long range telemetry is enabled by switched dipole antennas. The switched dipole antennas may be oriented with respect to the sensors to avoid interference between the sensor operations and the communication functions. For instance, the switched dipole antenna may be oriented with respect to the ground plane to optimize horizontally polarized long distance radio telemetry, given the variable azimuthal orientation of the balloon payload, in certain cases, given Federal Communications Commission (FCC) limitations on the effective isotropic radiative power (EIRP) for the 900 MHz Industrial, Scientific and Medical (ISM) radio band. In examples, the antenna configuration enables data to be returned up to 400 kilometer range, while reducing payload coast and complexity compared to long range telemetry systems with similar range and performance.

In example embodiments, the system includes a radio link to the venting valve of the balloon to enable longer tether lengths and simpler balloon rigging. In other embodiments, the venting valve may be a low cost, light weight valve with an altitude and ascent rate dependent open/close control setting for reliable control of balloon apogee and descent rate. Some embodiments may include a tether unwinder and parachute. In certain embodiments, the system may further include a line cutter, such as a resistor-based line cutter, for simple, low-cost, reliable balloon cutaway. Some example systems may include internal temperature control for battery self-heating, enabling long-life operation in extremely cold ambient and stratospheric conditions, even with lightweight, disposable batteries. The combination of features may enable a one-person launch, thus reducing operations cost.

In embodiments, the system includes software controlled, analog front end electronics including unique features, such as auto-zero capability, self-calibration methods to enable the use of low-cost sensing elements without costly pre-flight individual sensor calibration, and pipelined software architecture.

Aspects of the embodiments disclosed herein enable low-cost instrument and low-cost flight operations to allow widespread and high cadence measurements of stratospheric environmental conditions. Certain embodiments enable balloon and payload systems small and lightweight enough for single person launch, even in high wind conditions, thus reducing cost and complexity. The small payloads in the systems disclosed herein may qualify as an “unregulated free balloon” in the US (e.g., as defined in FAA FAR Part 101) and “light” under European Union regulations, thus simplifying the airspace permission and notification protocols.

### Instrument and Support System Configuration

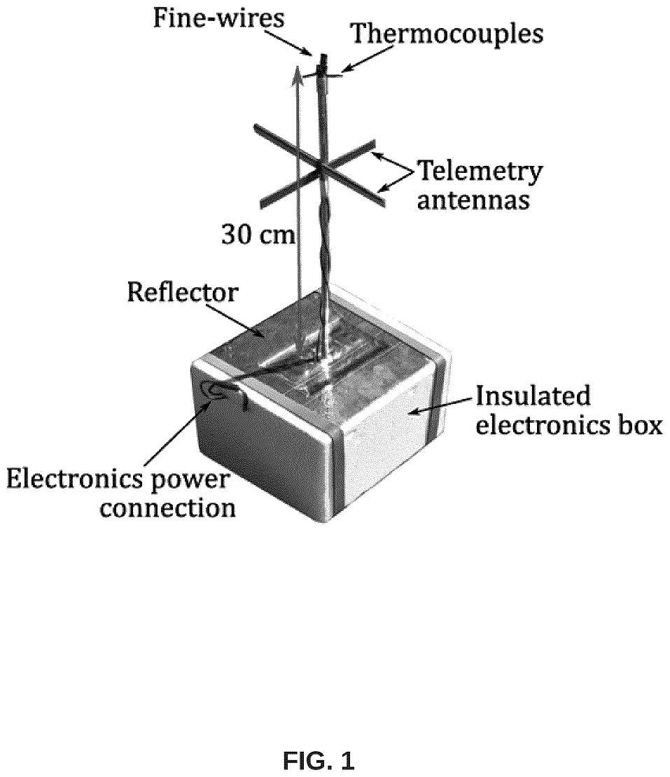

FIG. 1 shows an exemplary embodiment of a gondola containing the instrument payload that has been developed at the University of Colorado—Boulder for the Hypersonic Flight in the Turbulent Stratosphere (HYFLITS) project. In-situ turbulence measurements may be made by lofting the gondola on low-cost weather balloons that are vented at apogee such that the instrument descends slowly while the probe (shown as fine-wires in FIG. 1) is oriented downward toward the ground. In this way, the fine wires are not in the wake of the balloon or the avionics instrumentation, such as the telemetry antennas and the electronics contained in the insulated electronics box.

As described above, in flight, the gondola would be oriented such that the fine-wire turbulence instruments are pointing downward (i.e., opposite the orientation shown). In certain examples, the measurement system may include custom fine-wire instruments to measure turbulent fluctuations in velocity (via a hot-wire anemometer) and temperature (via a cold-wire thermometer).

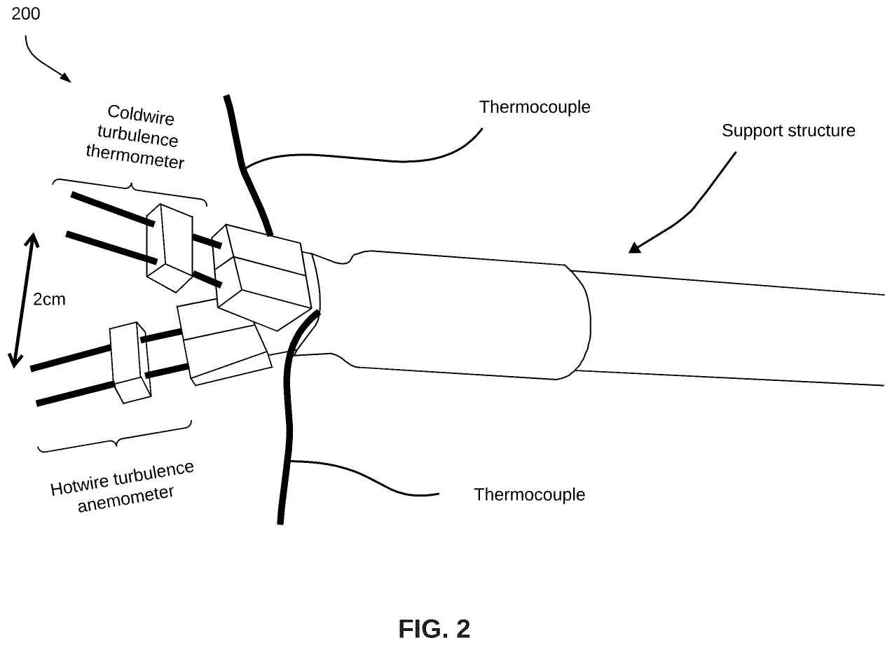

In an example, a fine-wire turbulence instrument probe tip 200 shown in FIG. 2 may be integrated into the system with thermocouples, as shown in FIG. 1. In particular, FIG. 2 shows an arrangement of a coldwire turbulence thermometer, a hotwire turbulence anemometer, arranged at an angle with a 2 cm separation at the end of a supporting structure, in accordance with an embodiment. Additional thermocouples may provide additional temperature sensing for the system, in certain examples. In certain embodiments, an exemplary electronics assembly connected with the fine-wire turbulence instrument probe tip may further include supporting avionics for real time data telemetry. In examples, the electronics assembly may include a printed circuit board less than 10 cm×8 cm, weigh less than 100 g, and may be mounted within the insulated electronics box of FIG. 1. As an example, the insulated electronics box may be partially or wholly formed of a closed-cell extruded polystyrene foam (XPS), such as STYROFOAM™ brand insulation.

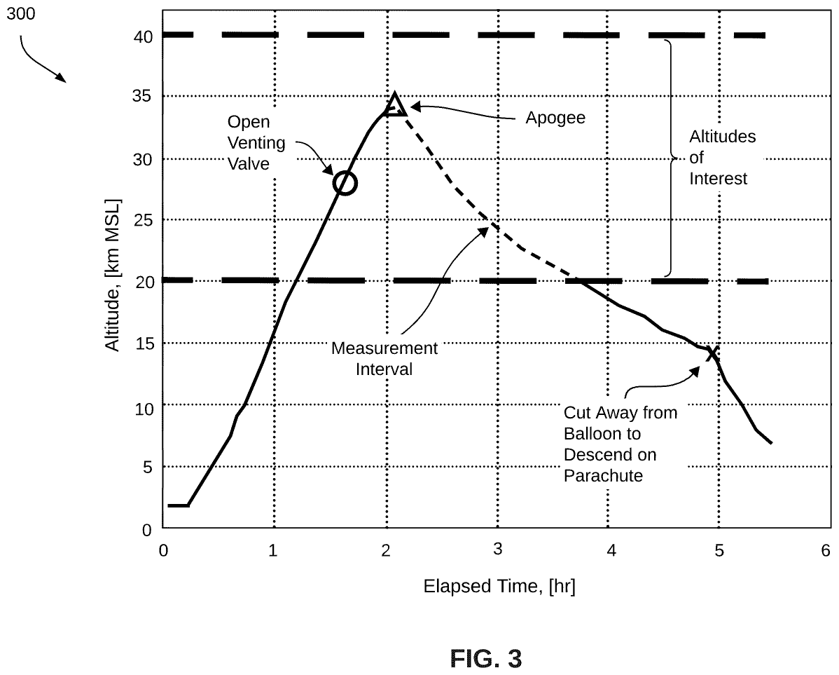

The fine-wire sensing elements in FIG. 2 may be placed at the end of a thin boom that extends 30 cm below the main gondola (FIG. 1), as an example. Measurements of turbulence may be made during the descent phase of the balloon trajectory (see FIG. 3). In particular, FIG. 3 shows a graph 300 illustrating balloon altitude as a function of elapsed time, showing the timing of various events during measurement, in accordance with an embodiment.

The sensor placement and measurement scheme enables the sensors to remain upstream of the probe support, gondola body, and balloon such that the measured turbulence is minimally influenced by the presence of these supporting structures. In an embodiment, the turbulence instrument measures velocity and temperature fluctuations in the atmosphere as the balloon slowly descends from apogee at a nominal rate of 2 m/s. While these fluctuations are stochastic, they follow a characteristic cascade of variations from large scales (low wavenumbers) to small scales (high wavenumbers) according to the well-validated Kolmogorov K41 theory, resulting in a so-called inertial subrange where spectral energy has a characteristic slope, decreasing with wavenumber. Further details of the gondola and experimental measurements are described, for example, in Roseman, et al., “A Low-Cost Balloon System for High-Cadence, In-Situ Stratospheric Turbulence Measurements,” AIAA AVIATION 2021 FORUM, published online 2021 Jul. 28, which is incorporated herein by reference in its entirety.

### Software Controlled Analog Front End Electronics

In certain embodiments, the system includes software controlled analog front end electronics, which provides a variety of advantages over existing fine-wire turbulence instruments. For example, the electronics system and controls software may include features such as:

1. Gain control: Enables gains to be changed as atmospheric conditions (e.g., density) may vary significantly during deployment.

2. Centering speed: Enables artifacts of radio frequency (RF) transmissions on measurements to be significantly reduced by changing centering speed between measurement and RF transmission intervals.

3. Offset control: Enables operating point on the nonlinear bridge imbalance characteristic to be set consistently in the presence of amplifier offset variations over a manufacturing lot, thus allowing the use of lower cost sensors.

4. Wire excitation level control: Sets nominal wire overheat ratio, allowing this parameter to be changed with wire heat transfer property changes during flight.

5. Simultaneous control of hotwire and coldwire measurements: Both hotwire and coldwire measurements may be obtained with an essentially common analog front end electronics board. That is, the hotwire and coldwire use may be distinguished by only a few components supplemented after manufacturing, thus reducing the cost of manufacturing by the use of common parts and PCB board layout.

6. Weighted spectral averaging to compress data for long distance telemetry.

7. Segregated measurement and RF transmission intervals to reduce potential artifacts in the measured signals.

### Auto-Zero and Self-Calibration Capabilities

Conventionally, hotwire anemometers and coldwire thermometers are calibrated by comparing measurements to reference sensors operated at the conditions of interest. This process is difficult to achieve for turbulence measurements in the stratosphere, as on-board reference sensors for such conditions are generally not available. While similar conditions may be replicated with special purposes wind tunnels (see, for example, A. Mahon, et al., “A calibration system for low-velocity flows at stratospheric conditions,” Proc. AIAA Scitech 2020 Forum, 2020), pre-calibration of all fine-wire sensing elements over the range of pressures, temperatures, and flows that may be encountered by the instrument would be cost-prohibitive.

In contrast, the embodiments of the turbulence analysis system presented herein include methods for post-flight calibration utilizing a combination of self-calibration data generated in flight using a “chopping” procedure, enhanced by models of the heat transfer from the fine wires derived from first principles and computational fluid dynamics (CFD) studies, as well as models of the electronics used to process the fine wire heat transfer fluctuations.

Since the radial heat transfer from the fine wires is small under rarefied conditions, axial heat conduction to the supporting prongs may be significant, even for wires with a large length-to-diameter (L/D) aspect ratio. This condition may be taken into account using an analytic solution to the one-dimensional linearized heat equation for this situation, thus enabling the axial thermal conductance to be quantified relative to the radial conductance such that the radial fluctuations, relating to flow velocity over the wire, may be obtained. Comparison with numerical solutions obtained via nonlinear partial differential equation analyses shows that this analytic linearized solution provides bulk thermal conductance within 4% over the altitude ranges of interest. Further, this procedure takes into account the disturbance of the flow around the supporting prongs (see, for example, FIG. 2 above) using CFD simulations, thus resulting in simple empirical models enabling the velocity inferred at the wire to be referred to a free stream flow near the prongs, as will be described in detail below.

Generally, flow and temperature fluctuations at the turbulence analysis system result in electrical power fluctuations in the fine wires that can be measured, amplified, and digitized by electronics. In certain instances, the relationship between the measured wire power and flow velocity depends on the sensitivity of the measurable radial thermal conductance to flow speed and the average temperature rise of the hotwire. The sensitivity to flow speed may be computed using known properties of air at ambient temperature and pressure, along with the known properties of the fine wires (e.g., platinum wire). The average temperature rise of the hotwire may be derived, for example, as a byproduct of the chopping procedure that alternates wire excitation between hotwire and coldwire levels, as described in further detail below. The chopping procedure as described herein also enables direct measurement of a mean radial conductance value, which is necessary to relate temperature changes to wire power fluctuations in the coldwire.

In embodiments, the detected wire power fluctuations may be processed by an electronics circuitry, such as an analog electronics frontend, to provide voltage signals that are digitized and telemetered to the ground for post-flight calibration and conversion to turbulence parametrizations. The signal gain and frequency response of the electronics circuitry may be modeled to allow an inverse processing algorithm to convert the voltages to wire power and, in turn, to measurements of flow velocity and temperature fluctuations to complete the instrument calibration.

Further, the analog frontend may be configured to provide an auto-zero capability to enable high resolution measurements over a wide range of fine wire resistance changes due to the wide ambient temperature variation during flight as well as to account for any variation in manufacturing of the wire elements, thus allowing the use of low-cost manufacturing techniques for the fine wires. For example, the analog frontend may include electronics configured to be controlled by software to provide control of functions such as auto-zero speed, circuit gain, amplifier offsets, and wire excitation levels to implement a chopping procedure (described in detail below) and reduce effects of RF telemetry interference with the turbulence measurements.

In some embodiments, the turbulence parameterizations may be computed in post-flight analysis from spectral data generated onboard the atmospheric measurement system. This spectral data may be averaged, for example, in fractional-decade frequency intervals to provide data compression by a factor of 64, thus enabling long distance data transmission. In this way, the data captured by the atmospheric measurement system may be telemetered to the ground without requiring physical recovery of the payload data, thus obviating the need for balloon chains and reducing the cost of data collection. Further, the onboard electronics may be sufficiently low cost to be expendable. Optionally, no data from the atmospheric measurement system may be deleted after telemetry, thus preventing access to the data by nefarious parties.

In certain embodiments, the system described herein includes electronics circuitry and software to provide an auto-zero capability. The auto-zero capability may enable the use of low-cost sensor elements with a wide range of nominal wire resistance, as well as enable high resolution measurement over extremely large ambient temperature excursions (e.g., +40 to −60° C. as may be experienced during a high altitude balloon flight) that may cause the sensor element resistance to vary up to 40%.

As an example, the system described herein may include two very similar analog electronics boards: 1) one operating at relatively large power Pw so that the measurements of wire voltage and current are dominated by the velocity fluctuations of the flow (i.e., a hotwire anemometer), and the other operated at a very small wire power so that measurements are dominated by the temperature fluctuations of the flow (i.e., a coldwire thermometer). Both use an auto-zeroing approach that enables very large variations in wire resistance to be accommodated, whether due to variations in the wire fabrication process, or due to the changes induced by large variation in ambient temperature between ground launch and operation in the stratosphere. Thus, the instruments have a high-pass characteristic to only measure the fluctuations about the average value that occur at frequencies above about 1 Hz. Accordingly, it would be desirable to calibrate the sensitivity of the instruments to these higher frequencies, and these components of the velocity and temperature signals are very small relative to their average values.

### Fine-Wire Partial Differential Equation (PDE) Model for Heat Transfer

To understand the auto-zero functionality and other unique aspects of the system, we begin with fundamental modeling of the fine-wire heat transfer, taking into account the rarefied flow regime encountered by the turbulence measurement system in the stratosphere. Aspects of the turbulence measurement system relate to gathering of data for self-calibration of the voltage signals in terms of in-situ velocity and temperature fluctuations such that turbulence may be parameterized in terms of turbulent kinetic energy dissipation rate parameter E and the turbulent temperature structure parameter C_{T}². Both velocity and temperature may be measured using the fine wires. The resistance of the fine wires changes with temperature, and in turn the wire temperature is a balance between electrical heating and the heat transfer properties of the fine wires and their environment.

The fine wire is modeled as a long, thin cylinder with its axis transverse to the air flow, spanning the distance between the supporting prongs (e.g., as shown in FIG. 2). For example, the wires may have a typical diameter of d_{w}=5 μm and a length of L_{w}=2 mm for an L/d aspect ratio of 400.

A partial differential equation (PDE) model for wire heat transfer may be developed in a manner similar to that described by Bruun (see References list below). Electrical current Iw (in unites of amperes) passing through the wire produces Joule heating power in the wire, given in W/m (watt per unit axial length) by

$${I}_{w}^{2} {χ}_{w} / {A}_{w} \qquad [ Eq . 1 ]$$

where χ_{w} is the electrical resistivity of the wire (in Ω·m) and Aw is the wire cross-sectional area (in m²). This heating power is balanced by power loss to the environment, and to a rate of internal energy increase in the wire mass (per unit length) of

$${ρ}_{w} {A}_{w} {c}_{w} \frac{\partial {T}_{w}}{\partial t} \qquad [ Eq . 2 ]$$

where ρw is the density of the Platinum wire in [kg/m3] and cw is the heat capacity of Platinum (in J/kg·K). Tw is the temperature of the wire (in K).

The power loss to the environment is assumed to occur through two paths. The axial path is by conduction through the wire to the prongs, and through the prongs to the surrounding air. The radial path is directly from the wire surface to the surrounding air. Since the copper prongs have a cross-sectional area to the heating current that is about 2×10⁴ larger than the fine wire, and copper has a resistivity that is about 0.16 times that of platinum, there is negligible Joule heating in the prongs, so they are assumed to be at ambient air temperature Ta. The axial power loss per unit length is then given by

$$- {k}_{A} {A}_{w} \frac{{\partial }^{2} {T}_{w}}{\partial {x}^{2}} \qquad [ Eq . 3 ]$$

where k A is the thermal conductivity of Platinum in [W/m·K] and x is the axial displacement along the wire.

The radial power loss includes radiation, conduction and convection. Ignoring the radiation component (it is only about 0.2% of the total power budget, due to the <50 K overheat of the wire relative to ambient) the radial power loss per unit length is given by

$$π kNu \cdot ( {T}_{w} - {T}_{a} ) \qquad [ Eq . 4 ]$$

where k is the thermal conductivity of the air in [W/m·K] and Nu is the Nusselt number that relates the forced convective and conductive components of heat transfer to the air via

$$Nu = \frac{{d}_{w} h}{k} \qquad [ Eq . 5 ]$$

where h is the radial heat transfer coefficient (in W/m2·K). Note there is also natural convective heat transfer (due to buoyancy of the heated air), but this term is also neglected because it is much smaller than the forced convective component: the conventional limit of Reynolds number>(Grasshof number)^{1/3} for forced convection to dominate natural convection is exceeded by a factor of more than 30 for our wires and conditions in the stratosphere with airspeeds >2 m/s.

The power balance per unit length then results in the following one-dimensional PDE for temperature Tw(x, t) along the wire:

$$\frac{{I}_{w}^{2} ( t ) {χ}_{w}}{{A}_{w}} = - {k}_{A} {A}_{w} \frac{{\partial }^{2} {T}_{w} ( x , t )}{\partial {x}^{2}} + π kNu \cdot ( {T}_{w} ( x , t ) - {T}_{a} ( t ) ) + {ρ}_{w} {A}_{w} {c}_{w} \frac{\partial {T}_{w} ( x , t )}{\partial t} \qquad [ Eq . 6 ]$$

The Nusselt number Nu is a function of the air flow rate via the wire Reynolds number Re_{w}=d_{w}U_{w}/ν and a function of air density via the wire Knudsen number Kn_{w}=λ/d_{w}. Here, Uw is the transverse flow velocity of the flow near the wire (in m/s), ν is the kinematic viscosity of the air (in m²/s), and λ is the molecular mean free path of the air (in m). Note that Nu is formally also a function of wire temperature due to the dependence of ν and λ on the so-called air film temperature T_{f}=(Tₐ+T_{w})/2. The conductivity k is also a function of the air film temperature. These temperature effects on Nu and k make the PDE nonlinear. Moreover, the local air flow rate is not constant with location x along the wire due to the obstructive effects of the supporting prongs, which divert the free stream flow Uₛ near the prongs, so Re_{w} also varies with x due to variation of U_{w} with x. It is also assumed that the ambient temperature does not vary with x along the wire, since any temperature differences over distances smaller than the wire length will be averaged out in the electrical measurements.

In the rarefied conditions in the stratosphere, the radial heat transfer from the wire is not a strong function of flow velocity. Also, the temperature dependence of Nu and k is weak, at least for small overheat temperatures of the wire relative to ambient. Considering Nu and k to be constants Nu* and k*, respectively, over the length of the wire, Eq. 6 becomes a linear PDE in x. Also note that the Joule heating power is itself a function of wire temperature, due to the temperature coefficient of resistance α so that χ_{w} is a (locally) linear function of temperature via

$${χ}_{w} = {χ}_{w o} [ 1 + α ( {T}_{w} ( x , t ) - {T}_{a} ) ] \qquad [ Eq . 7 ]$$

where χ_{wo} is the resistivity of Platinum at ambient temperature Tₒ (usually 0° C.). This model is generally accurate to within 0.22% over the temperature range of −60° C. to +60° C.

It will be convenient later to express χ_{w} in terms of temperature rise over the ambient temperature Tₐ(t)

$${χ}_{w} = {χ}_{w o} [ 1 + α ( {T}_{w} ( x , t ) - {T}_{a} ( t ) + {T}_{a} - {T}_{o} ) ] = {χ}_{wa} ( t ) + {χ}_{wo} α ( {T}_{w} ( x , t ) - {T}_{a} ( t ) ) \qquad [ Eq . 8 ]$$

Substituting the expression of Eq. 7 into Eq. 6 and multiplying by L_{w}, we obtain

$$\frac{{I}_{w}^{2} ( t ) {χ}_{wo} ( t ) {L}_{w}}{{A}_{w}} = - \frac{{k}_{A} {A}_{w}}{{L}_{w}} {L}_{w}^{2} \frac{{\partial }^{2} {T}_{w} ( x , t )}{\partial {x}^{2}} + ( π k * Na * {L}_{w} - \frac{α {I}_{w}^{2} ( t ) {χ}_{wo} {L}_{w}}{{A}_{w}} ) ( {T}_{w} ( x , t ) - {T}_{a} ( t ) ) + {ρ}_{w} {A}_{w} {L}_{w} {c}_{w} \frac{\partial {T}_{w} ( x , t )}{\partial t} \qquad [ Eq . 9 ]$$

To simplify notation in the following, the following definitions are used:

$${R}_{w o} = {χ}_{w o} {L}_{w} / {A}_{w} Total wire electrical resistance at To ( in Ohm ) \qquad [ Eq . 10 ]$$

$${R}_{w a} ( t ) = {χ}_{w a} {L}_{w} / {A}_{w} \\ Total wire electrical resistance at {T}_{a} ( t ) ( in Ohm ) \qquad [ Eq . 11 ]$$

$${H}_{R}^{*} = π k * Nu * {L}_{w} \\ Radial thermal conductance parameter ( in W / K ) \qquad [ Eq . 12 ]$$

$${H}_{A}^{*} = {k}_{A} {A}_{w} / Lw Axial thermal conductance parameter ( in W / K ) \qquad [ Eq . 13 ]$$

$${m}_{w} = {ρ}_{w} {A}_{w} {L}_{w} Wire total mass ( in kg ) \qquad [ Eq . 14 ]$$

Using the above definitions, in combination with Eq. 8, we obtain

$${I}_{w}^{2} ( t ) {R}_{wa} = - {H}_{A}^{*} {L}_{w}^{2} \frac{{\partial }^{2} {T}_{w} ( x , t )}{\partial {x}^{2}} + ( {H}_{R}^{*} - α {I}_{w}^{2} ( t ) {R}_{wa} ) ( {T}_{w} ( x , t ) - {T}_{a} ( t ) ) + {m}_{w} {c}_{w} \frac{\partial {T}_{w} ( x , t )}{\partial t} \qquad [ Eq . 15 ]$$

This PDE admits a separable solution in the following form:

$$Tw ( x , t ) = Ta ( t ) + τ ( t ) ( 1 - θ ( x ) ) \qquad [ Eq . 16 ]$$

Inserting the expression in Eq. 16 into Eq. 15, we obtain:

$${I}_{w}^{2} ( t ) {R}_{wa} - ( {m}_{w} {c}_{w} ) \frac{\partial {T}_{a} ( t )}{\partial t} = {H}_{A}^{*} {L}_{w}^{2} τ ( t ) \frac{{\partial }^{2} θ ( x )}{\partial {x}^{2}} + ( 1 - θ ( x ) ) [ τ ( t ) ( {H}_{R}^{*} - α {I}_{w}^{2} ( t ) {R}_{wa} ) + {m}_{w} {c}_{w} \frac{\partial τ ( t )}{\partial t} ] \qquad [ Eq . 17 ]$$

Since the left-hand side of Eq. 17 is not a function of x, the θ(x) terms on the right-hand side must satisfy the following relationship:

$${H}_{A}^{*} {L}_{w}^{2} τ ( t ) \frac{{\partial }^{2} θ ( w )}{\partial {x}^{2}} - θ ( x ) b ( t ) = 0 \qquad [ Eq . 18 ]$$

where b(t) is the bracketed factor in Eq. 17. By noting that ∂² cosh(δx)/∂x²=δ² cosh (δx), the relationship is satisfied by θ(x) in the form

$$θ ( x ) = B cosh ( δ x ) \qquad [ Eq . 19 ]$$

where

$${δ}^{2} = \frac{b ( t )}{{H}_{A}^{*} {L}_{w}^{2} τ ( t )} \qquad [ Eq . 20 ]$$

and B is chosen to satisfy the boundary conditions that θ(L_{w}/2)=θ(−L_{w}/2)=1 so that the temperature rise goes to zero at the wire attachment on the prongs:

$$θ ( x ) = cosh ( δ x ) / cosh ( δ {L}_{w} / 2 ) \qquad [ Eq . 21 ]$$

Note that (20) requires that b(t)/(H*_{A}L_{w}²r(t))>0. wτ(t))>0, or

$$( {H}_{R}^{*} - α {I}_{w}^{2} ( t ) {R}_{wo} ) + \frac{( {m}_{w} {c}_{w} )}{τ ( t )} \frac{\partial τ ( t )}{\partial t} > 0 \qquad [ Eq . 22 ]$$

which restricts the size of the time variations in τ(t) relative to τ(t) itself. It is noted that αI_{w}²(t)R_{wo} must also be small relative to H*_{R} which is the case when the heating current I_{w}(t) is small enough.

This solution for θ(x) reduces the PDE in Eq. 15 to an ordinary differential equation (ODE) for the time varying factor τ(t) in T_{w}(x, t)−Tₐ(t):

$${I}_{w}^{2} ( t ) {R}_{wa} ( t ) - \frac{{dT}_{a} ( t )}{dt} ( {m}_{w} {c}_{w} ) = τ ( t ) ( {H}_{R}^{*} - α {I}_{w}^{2} ( t ) {R}_{wo} ) + \frac{d τ ( t )}{dt} ( {m}_{w} {c}_{w} ) \qquad [ Eq . 23 ]$$

Given the independent functions I_{w}(t), R_{wa}(t), and Tₐ(t), Eq. 23 may be solved for τ(t), which then determines the b(t) in Eq. 20, and the temperature profile of the wire can be found from Eq. 21 and the known relationship T_{w}(x, t)=Tₐ(t)+τ(t) (1−θ(x)).

Strictly speaking, Eq. 23 is a weakly nonlinear ordinary differential equation, due to the dependence of k* and Nu* in H*_{R} on temperature, and the presence of the αI_{w}²(t)R_{wo} term. In the case where Tₐ is constant and I_{w} is constant at Ī_{w}, the steady state solution τ may be expressed as:

$$\overline{τ} = \frac{{\overline{I}}_{w}^{2} {R}_{wa}}{{H}_{R}^{*} - α {\overline{I}}_{w}^{2} {R}_{wa}} \qquad [ Eq . 24 ]$$

The linearized steady state wire temperature profile is then

$${\overline{T}}_{w} ( x ) = {\overline{T}}_{a} + \frac{{\overline{I}}_{w}^{2} {R}_{wa}}{{H}_{R}^{*} - α {\overline{I}}_{w}^{2} {R}_{wa}} ( 1 - \frac{cosh ( δ x )}{cosh ( δ {L}_{w} / 2 )} ) \qquad [ Eq . 25 ]$$

where the over lines indicate steady state values.

A finite element model (FEM) may be used to calculate numerical solutions of Eq. 6, and the numerical simulations may be used to quantify the accuracy of the linearized analytical solution given in Eq. 25 to generate the temperature profiles across a wire.

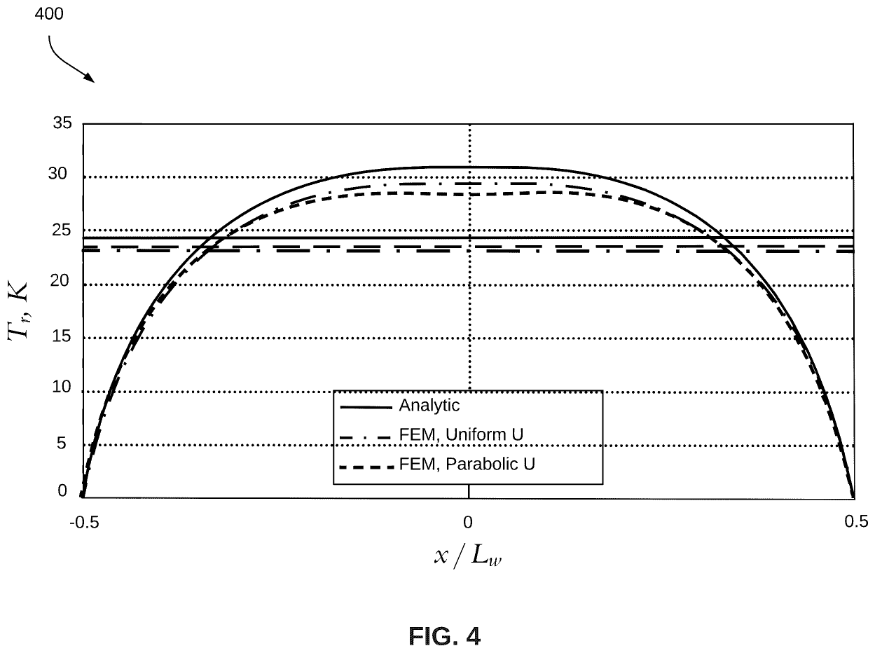

The FEM allows for ambient gas properties to vary along the wire length according to the local film temperature. This variation leads to variable values of local Nu and k, unlike with the analytical solution. Both uniform and parabolic velocity profiles were simulated with the FEM. FIG. 4 shows an example of the temperature profile modeled by Eq. 23 (solid line), FEM with a uniform velocity profile U (long dash line), and FEM with a parabolic velocity profile U (dotted line). Average temperature over the wire length is shown by the horizontal lines with corresponding line types. In particular, FIG. 4 shows a graph 400 illustrating the temperature profile across a wire according to Eq. 25 and finite element simulations with uniform and parabolic velocity profiles. Horizontal lines indicate the average temperature for each profile. Conditions correspond to a 5 μm wire in a 1 m/s flow at 15 km altitude. By inspection of FIG. 4, it can be seen that the average velocity between the uniform and parabolic velocity profiles matches. The parabolic profile represents the case where blockage from the wire support prongs is maximum. Average velocities of 1, 2, and 3 m/s were simulated.

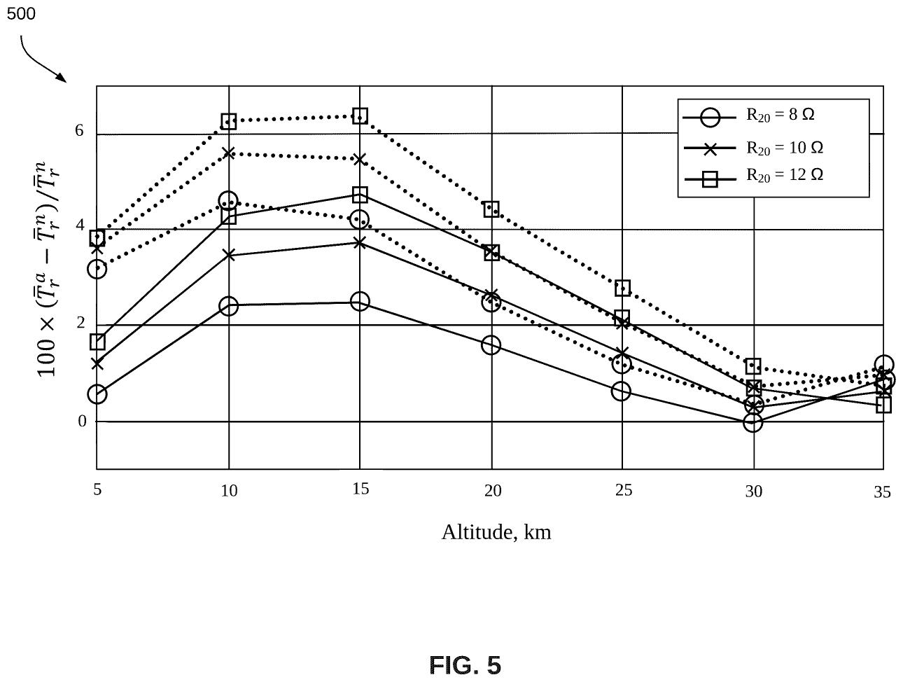

FIG. 5 shows simulations with ambient pressure and temperature corresponding to altitudes between 5 and 35 km, assuming a wire diameter of 5 μm. In particular, FIG. 5 shows a graph 500 illustrating the % difference in average temperature rise between finite element (i.e., numerical) (T̅ᵣⁿ) and analytical (T̅ᵣ^{a}) solutions over a range of altitudes (i.e., 100×(T̅ᵣ^{a}−T̅ᵣⁿ)/T̅ᵣⁿ as a function of altitude in km). Dashed and solid lines are results for FEM with parabolic and uniform velocity profiles, respectively. Results shown are for 1 m/s flow over the wire. Wire length has been adjusted in order to achieve wire resistances of 8, 10, and 12Ω at 20 C (R20). Current through the wire is set such that the voltage drop across the wire is 0.13 V. These simulated conditions span the expected range of conditions for an exemplary fine-wire system.

As shown in FIG. 5, the difference in average wire temperature rise between all numerical (T̅ᵣⁿ) and analytical (T̅ᵣ^{a}) is less than 1.5 K or 6.4% relative to T̅ᵣⁿ. The difference between the analytic solution and the parabolic velocity profile simulation is generally higher than the difference from the uniform velocity case. This characteristic indicates that the parabolic profile simulation predicts a lower average wire temperature than both the analytic solution and the uniform profile simulation, likely due to the higher velocity near the wire center which increases the radial power loss at the location where temperature tends to be highest. This effect tends to depress the peak wire temperature relative to the two other solutions, as is observed in FIG. 5 above.

The largest difference between the analytic prediction and both FEM simulations occurs at 15 km altitude conditions for a wire with R20=12Ω in a 1 m/s flow. FIG. 5 shows the temperature profile according to the analytical (solid blue line) and finite element (dashed black line) solutions for this worst-case scenario. The analytical solution predicts a higher temperature rise in the middle of the wire relative to the numerical solutions, leading to a 4.7% and 6.4% difference in predicted average temperature rise from the uniform and parabolic profile simulations, respectively, in these exemplary simulation results as shown.

### Bulk Wire Properties

The fine wire electrical instrument cannot measure the wire temperature profile, as the system measures wire current I_{w}(t) and the voltage drop V_{w}(t) across the wire to calculate total wire resistance R_{w}(t)=V_{w}(t)I_{w}(t) and total wire power P_{w}(t)=V_{w}(t)_{w}(t). Thus, to relate the electrical measurements to the wire heat transfer model, we need to develop relationships between the wire voltage and current as they depend on “bulk” or “end-to-end” wire heat transfer properties.

We can integrate Eq. 6 over the length of the wire to obtain an analytic model for the total wire Joule heating power on the left hand side, using Eq. 8 and the temperature rise definition Tᵣ(x, t)=T_{w}(x, t)−Tₐ(t)

$${P}_{w} ( t ) = {\int }_{- {L}_{w} / 2}^{Lw / 2} {I}_{w}^{2} ( t ) {Χ}_{w} / {A}_{w} dx = \frac{{I}_{w}^{2} ( t ) {L}_{w}}{{A}_{w}} ( {Χ}_{wa} ( t ) + \frac{{αΧ}_{wo}}{{L}_{w}} {\int }_{- {L}_{w} / 2}^{Lw / 2} {T}_{r} ( x , t ) dx ) \qquad [ Eq . 26 ]$$

Let T̅ᵣ(t) be the mean value of the temperature profile Tᵣ(x, t) over the wire length L_{w}. Then Eq. 26 becomes:

$${P}_{w} ( t ) = {I}_{w}^{2} ( t ) ( {R}_{wa} ( t ) + α {R}_{wo} {\overline{T}}_{r} ( t ) ) \qquad [ Eq . 27 ]$$

Similarly, since the total wire resistance R_{w} is given by

$${R}_{w} = {\int }_{- {L}_{w} / 2}^{Lw / 2} {Χ}_{w} / {A}_{w} dx \qquad [ Eq . 28 ]$$

it can be seen that

$${R}_{w} ( t ) = {R}_{wa} ( t ) + α {R}_{wo} {\overline{T}}_{r} ( t ) \qquad [ Eq . 29 ]$$

and total wire Joule heating power is given by P_{w}(t)=I_{w}²(t)R_{w}(t) as expected.

Integrating the second term on the right of Eq. 6 in the same way, and using the definition of the radial thermal conductance parameter of Eq. 12, produces the portion of total power flowing in the radial direction to ambient:

$${P}_{R} ( t ) = {\int }_{- {L}_{w} / 2}^{Lw / 2} π k * Nu * {T}_{r} ( x , t ) dx = {H}_{R}^{*} \frac{1}{{L}_{w}} {\int }_{- {L}_{w} / 2}^{Lw / 2} {T}_{r} ( x , t ) dx = {H}_{R}^{*} {\overline{T}}_{r} ( t ) \qquad [ Eq . 30 ]$$

Thus, the total radial power does not depend on the shape of the temperature profile across the wire, but only on the mean temperature rise across the wire. The mean temperature rise may be found by direct integration of the solution Tᵣ(x, t):

$${\overline{T}}_{r} ( t ) = \frac{τ ( t )}{{L}_{w}} {\int }_{- {L}_{w} / 2}^{Lw / 2} ( 1 - \frac{cosh ( δ x )}{cosh ( δ {L}_{w} / 2 )} ) dx = τ ( t ) ( 1 - \frac{2 tanh ( δ {L}_{w} / 2 )}{δ {L}_{w}} ) \qquad [ Eq . 31 ]$$

The axial power loss can then be found by integration of the first term on the right in Eq. 6, by first deriving the second partial of T_{w}(x, t):

$$\frac{{\partial }^{2} {T}_{w} ( x , t )}{\partial {x}^{2}} = \frac{{\partial }^{2} {\overline{T}}_{r} ( x , t )}{\partial {x}^{2}} = - τ ( t ) {δ}^{2} \frac{cosh ( δ x )}{cosh ( δ {L}_{w} / 2 )} = {δ}^{2} ( {T}_{r} ( x , t ) - τ ( t ) ) \qquad [ Eq . 32 ]$$

Then the axial power is expressible as:

$${P}_{A} ( t ) = {\int }_{- {L}_{w} / 2}^{Lw / 2} - {k}_{A} {A}_{w} \frac{{\partial }^{2} {T}_{w} ( x , t )}{\partial {x}^{2}} dx = - {k}_{A} {A}_{w} {L}_{w} {δ}^{2} ( {\overline{T}}_{r} ( t ) - τ ( t ) ) \qquad [ Eq . 33 ]$$

From Eq. 31, we can write:

$${\overline{T}}_{r} ( t ) - τ ( t ) = ( 1 - \frac{1}{1 - \frac{2 tanh ( δ {L}_{w} / 2 )}{δ {L}_{w}}} ) {\overline{T}}_{r} ( t ) = ( \frac{- 2 tanh ( δ {L}_{w} / 2 )}{δ {L}_{w} - 2 tanh ( δ {L}_{w} / 2 )} ) {\overline{T}}_{r} ( t ) \qquad [ Eq . 34 ]$$

Then using Eq. 13 gives:

$${P}_{A} ( t ) = [ {H}_{A}^{*} {L}_{w}^{2} {δ}^{2} ( \frac{2 tanh ( δ {L}_{w} / 2 )}{δ {L}_{w} - 2 tanh ( δ {L}_{w} / 2 )} ) ] {\overline{T}}_{r} ( t ) \qquad [ Eq . 35 ]$$

Finally, the integral over wire length of the third term on the right of Eq. 6 is the total power that raises the internal energy of the wire:

$${P}_{I} ( t ) = {\int }_{- {L}_{w} / 2}^{Lw / 2} {ρ}_{w} {A}_{w} {c}_{w} \frac{\partial {T}_{w} ( x , t )}{\partial t} dt = ( {m}_{w} {c}_{w} ) ( \frac{d {\overline{T}}_{r} ( t )}{dt} + \frac{{dT}_{a} ( t )}{dt} ) \qquad [ Eq . 36 ]$$

We may also define the following terms:

$${H}_{R} = {H}_{R}^{*} Bulk radial thermal conductance ( in W / K ) \qquad [ Eq . 37 ]$$

$${η}^{2} = {( {L}_{w} δ )}^{2} = \frac{{H}_{R}^{*} - α {I}_{w}^{2} ( t ) {R}_{wo}}{{H}_{A}^{*}} Dimensionless conductivity ratio \qquad [ Eq . 38 ]$$

$${H}_{A} = {H}_{A}^{*} {η}^{2} ( \frac{2 tanh ( η / 2 )}{η - 2 tanh ( η / 2 )} ) Bulk axial thermal conductance ( in W / K ) \qquad [ Eq . 39 ]$$

$$H = {H}_{R} + {H}_{A} Total thermal conductance ( in W / K ) \qquad [ Eq . 40 ]$$

$${\overline{T}}_{w} ( t ) = {\overline{T}}_{r} ( t ) + {T}_{a \vert} ( t ) Mean wire temperature over wire length ( in K ) \qquad [ Eq . 41 ]$$

$${m}_{w} {c}_{w} = {C}_{w} Thermal mass of the wire ( in J / K ) \qquad [ Eq . 42 ]$$

Then, the bulk power versus mean wire temperature relationship may be expressed as:

$${P}_{w} ( t ) = {P}_{R} ( t ) + {P}_{A} ( t ) + {P}_{I} ( t ) = ( {H}_{R} + {H}_{A} ) ( {\overline{T}}_{w} ( t ) - {T}_{a} ( t ) ) + {C}_{w} \frac{d {\overline{T}}_{w} ( t )}{dt} = H \cdot ( {\overline{T}}_{w} ( t ) - {T}_{a} ( t ) ) + {C}_{w} \frac{d {\overline{T}}_{w} ( t )}{dt} \qquad [ Eq . 43 ]$$

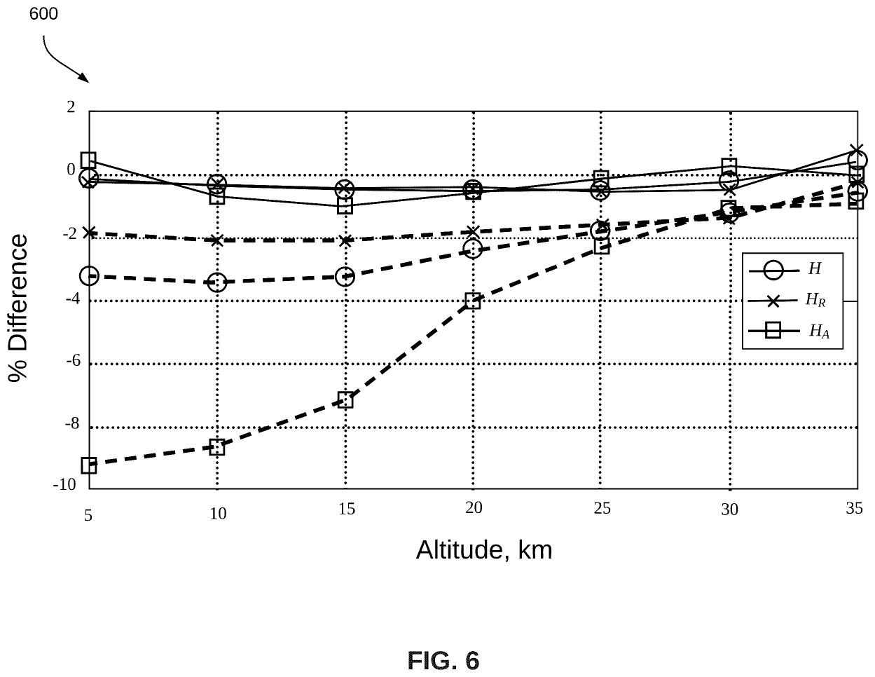

Similar to the wire temperature study above, the finite element model with both a uniform and parabolic velocity profile was also used to quantify the accuracy of the analytical solution result for bulk thermal conductance. FIG. 6 shows the difference in predicted H, HR, and HA relative to the numerical simulation results at various altitude conditions. More particularly, FIG. 6 shows a graph 600 of the difference between the bulk wire thermal conductance results between the numerical and analytical solutions over a range of altitudes, in accordance with an embodiment. Solid and dotted lines show comparison between analytic and uniform and between analytic and parabolic flow velocity FEM results, respectively. Results shown are for a wire with R20=10Ω in a 3 m/s flow.

Data shown in FIG. 6 are for a wire with R20=10Ω in a 3 m/s flow. The difference between the analytic and uniform profile simulation is everywhere less than 1.7% for H, H_{R}, and HA. However, larger differences are observed between the analytic and parabolic profile simulations (dotted lines). The difference is generally larger at lower altitudes. However, CFD results show that the uniform profile becomes more accurate than the parabolic profile at lower altitudes, as will be discussed in more detail below.

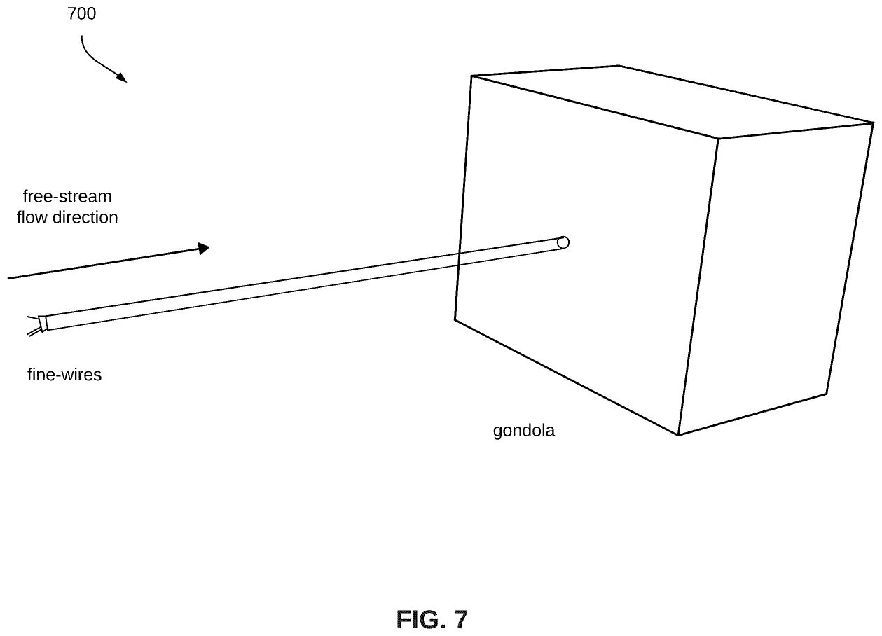

It should be noted that the analytic/numerical difference in temperature rise shown in FIG. 6 follows a different pattern with altitude from the analytic/numerical difference in thermal conductance shown in FIG. 7. Analytic and numerical solutions assume the same physical parameters (i.e., wire dimensions, wire material properties, and free-stream gas properties) and the same voltage drop across the wire. The voltage across the wire may be constrained to 0.13 V, as the hotwire circuit generally provides. By fixing the voltage, both the current through the wire and the temperature of the wire may be derived as results of the physical model such that both temperature rise and power loss may be different between the analytic and numerical solutions for a particular set of physical properties.

### Small Signal Model

An exemplary fine-wire turbulence measurement instrument may include two similar analog electronics boards: one operating at relatively large power P_{w} so that the measurements of wire voltage and current are dominated by the velocity fluctuations of the flow (i.e., a hotwire anemometer), and the other operated at a very small wire power so that measurements are dominated by the temperature fluctuations of the flow (i.e., a coldwire thermometer). Both boards may implement an auto-zeroing approach to enable very large mean variations in wire resistance to be accommodated, whether due to variations in the wire fabrication process, or due to the changes induced by large variation in ambient temperature between ground launch and operation in the stratosphere. Thus, the measurement system may exhibit a high-pass characteristic that only measures the fluctuations about the average value that occur at frequencies above about 1 Hz. Accordingly, it would be of interest to calibrate the sensitivity of the system to these higher frequencies, and these components of the velocity and temperature signals are assumed to be very small relative to their mean values.

Consider all the signals of interest to consist of average values (indicated by a long over-bar) plus a small deviation about the average (indicated by a Δ in front of the signal). Thus:

$$U ( t ) = U ( t ) + Δ U ( t ) Air velocity ( in m / s ) \qquad [ Eq . 44 ]$$

$${T}_{a} ( t ) = {T}_{a} ( t ) + Δ {T}_{a} ( t ) Air temperature ( in K ) \qquad [ Eq . 45 ]$$

Note the average values are also functions of time, but these are assumed to change much more slowly than the Δ deviations in the air velocity and temperature.

The first-order changes due to turbulent fluctuations in Eq. 43 may be found as follows, noting that the high frequency fluctuations ΔTₐ(t) are not present at the prongs, due to their relatively large thermal mass, so the axial power loss is not a function of ΔTₐ(t) —only the radial power loss is. Similarly, only the radial conductance varies as a function of high frequency fluctuations ΔU(t). So

$$Δ ( {H}_{R} ( {\overline{T}}_{w} - {T}_{a} ) ) = {\overline{H}}_{R} ( Δ {\overline{T}}_{w} - Δ {T}_{a} ) + Δ {H}_{R} ( {\overline{\overline{T}}}_{w} - {\overline{T}}_{a} ) \qquad [ Eq . 46 ]$$

$$and$$

$$Δ ( {H}_{A} ( {\overline{T}}_{w} - {T}_{a} ) ) = {\overline{H}}_{A} Δ {\overline{T}}_{w} \qquad [ Eq . 47 ]$$

Recall that the small over-bar indicates the average value over the wire length. Then Eq. 41 becomes:

$$Δ {P}_{w} = Δ {H}_{R} ( {\overline{\overline{T}}}_{w} - {\overline{T}}_{a} ) + ( {\overline{H}}_{R} + {\overline{H}}_{A} ) Δ {\overline{T}}_{w} - {\overline{H}}_{R} Δ {T}_{a} + {C}_{w} \frac{d Δ {\overline{T}}_{w}}{dt} \qquad [ Eq . 48 ]$$

Rearranging the expressions in Eq. 46 gives

$$Δ {H}_{R} {\overline{\overline{T}}}_{r} - {\overline{H}}_{R} Δ {T}_{a} = Δ {P}_{w} - ( {\overline{H}}_{R} + {\overline{H}}_{A} ) Δ {\overline{T}}_{w} - {C}_{w} \frac{d Δ {\overline{T}}_{w}}{dt} = Δ {P}_{E} \qquad [ Eq . 49 ]$$

where all terms on the right-hand side of the first equality result in measurable electrical power variations ΔPE. As recognized herein, ΔP_{W} in ΔP_{E} is a function only of the known voltage variations applied to the Wheatstone bridge circuit that includes the fine wire, and the second two terms in ΔP_{E} may be found from the measured resistance variation in the fine wire. The values for average radial thermal conductance H̅_{R} and average wire temperature rise T̅ᵣ may be periodically estimated in-flight using the chopping procedure, discussed in further detail below.

The value for ΔH_{R} is dependent on turbulent fluctuations of velocity, and ΔTₐ represents turbulent fluctuations of flow temperature. Measured fluctuations ΔP_{E} can then be used to calculate values for ΔH_{R} and ΔTₐ. In the case of a hotwire, the first term on the left typically dominates the second term, so ΔH_{R} can be found given T̅ᵣ. In the case of the coldwire, the opposite is true such that the second term on the left typically dominates, providing a measurement of ΔTₐ given H̅_{R}. The size of the cross-coupling errors, i.e., the error induced by temperature fluctuations on the velocity measurement, and the error induced by flow velocity fluctuations on the temperature measurement, depend on both the scale factors T̅ᵣ and H̅_{R} as well as the size of the signals ΔH_{R} and ΔTₐ. If the raw time series of ΔP_{E} were available from both chopping phases, we could solve the 2-by-2 linear system of equations directly for ΔH_{R} and ΔTₐ without cross coupling error.

In an example system, due to limits on the telemetry data rates, the system may only send information about ΔP_{E} from one phase (e.g., phase 1 for the hotwire instrument, and phase 2 for the coldwire instrument), and this information may be in the form of frequency-bin averages of the power spectral density. Thus, a de-coupling solution for ΔH_{R} and ΔTₐ may not be possible.

Instead, the following approach may used: velocity is estimated ignoring the temperature effects, and temperature is estimated ignoring the velocity effects. Then, any error may be evaluated to see if the error is small relative to the estimated variables.

The turbulent temperature structure parameter C_{T}² may be estimated directly from the measurements of ΔTa. However, ΔH_{R} should first be related to turbulent velocity fluctuations ΔU before turbulent dissipation rate e may be estimated.

### Calculation of Velocity Fluctuations

The relationship between measured fluctuations in thermal conductance ΔH_{R} and velocity ΔU may be derived as follows. Ultimately, a model is needed for ∂H_{R}/∂U to convert ΔH_{R} to ΔU by

$$Δ U = {( \frac{\partial {H}_{R}}{\partial U} )}^{- 1} Δ {H}_{R} \qquad [ Eq . 50 ]$$

Empirical models for convective heat transfer from a circular cylinder are typically expressed analytically in terms of Reynolds (Re=ρUdw/μ) and Knudsen (Kn=λ/dw) numbers as

$$Nu = f ( Re \cdot Kn ) \qquad [ Eq . 51 ]$$

where Nu is a dimensionless scaling of thermal conductivity due to convection given earlier in Eq. 5 and with Eq. 10, the derivative of H_{R} with respect to Nu may be expressed as

$$\frac{\partial {H}_{R}}{\partial Nu} = π k * {L}_{w} \qquad [ Eq . 52 ]$$

An expression for ∂Nu/∂Re may be derived from empirical relations for wire power loss, (see, for example, the Xie reference cited below). The derivative of Re with respect to velocity is

$$\frac{\partial Re}{\partial U} = \frac{{pd}_{w}}{μ} \qquad [ Eq . 53 ]$$

Given the above relations, the dependence of convective thermal conductance on changes in free stream velocity can be written as

$$\frac{\partial {H}_{R}}{\partial U} = \frac{\partial {H}_{R}}{\partial Nu} \frac{\partial Nu}{\partial Re} \frac{\partial Re}{\partial U} \qquad [ Eq . 54 ]$$

Thus, the relationship between ΔH_{R} and ΔU may be expressed as:

$$Δ U = {[ \frac{\partial {H}_{R}}{\partial Nu} \frac{\partial Nu}{\partial Re} \frac{\partial Re}{\partial U} ]}^{- 1} Δ {H}_{R} \qquad [ Eq . 55 ]$$

$${{Δ U = [ ( π {kL}_{w} ) \frac{\partial Nu}{\partial Re} \vert}_{\overline{Re}} ( \frac{ρ {d}_{w}}{μ} ) ]}^{- 1} Δ {H}_{R} \qquad [ Eq . 56 ]$$

Further consolidation of the above expressions gives

$${{Δ U = \frac{μ}{π {kL}_{w} ρ {d}_{w}} ( \frac{\partial Nu}{\partial Re} \vert}_{\overline{Re}} )}^{- 1} Δ {H}_{R} \qquad [ Eq . 57 ]$$

Eq. 57 essentially relates turbulent fluctuations to measured or known quantities. Flow parameters μ, k, and ρ may be calculated at the wire film temperature and the ambient pressure. An analytical model for wire temperature as a function of axial position may be used to estimate the correct wire and film temperatures. The ideal gas law may be used to calculate ρ, Sutherland's law may be used to calculate μ, and the model from the NASA reference cited below may be used to calculate k. Wire diameter d and length L_{w} may be estimated from measurements of wire resistance and properties of platinum. The derivative of the power loss model ∂Nu/∂Re can be calculated at the average wire Reynolds number. Average Reynolds number R̅e̅ is calculated from the average velocity across the wire Ū and fluid properties described above.

Here, it is important to note that the average fluid velocity in the neighborhood of the wire Ū_{w} can be different from the free stream velocity Ūₛ due to the obstructing effects of the supporting prongs. This difference may be estimated using, for example, a computational fluid dynamics (CFD) model of flow around prongs of a geometry 700, as shown in FIG. 7, including the relative orientations of the fine wires respect to a gondola, with a free-stream flow direction as indicated by a thick arrow.

For example, using the exemplary geometry shown in FIG. 7, the flow velocity at a simulation inlet and the static pressure at the outlet may be specified. The wire may not be required in the calculation because its frontal area is several orders of magnitude smaller than that of the support prongs, such that any blockage caused by the wire is assumed negligible.

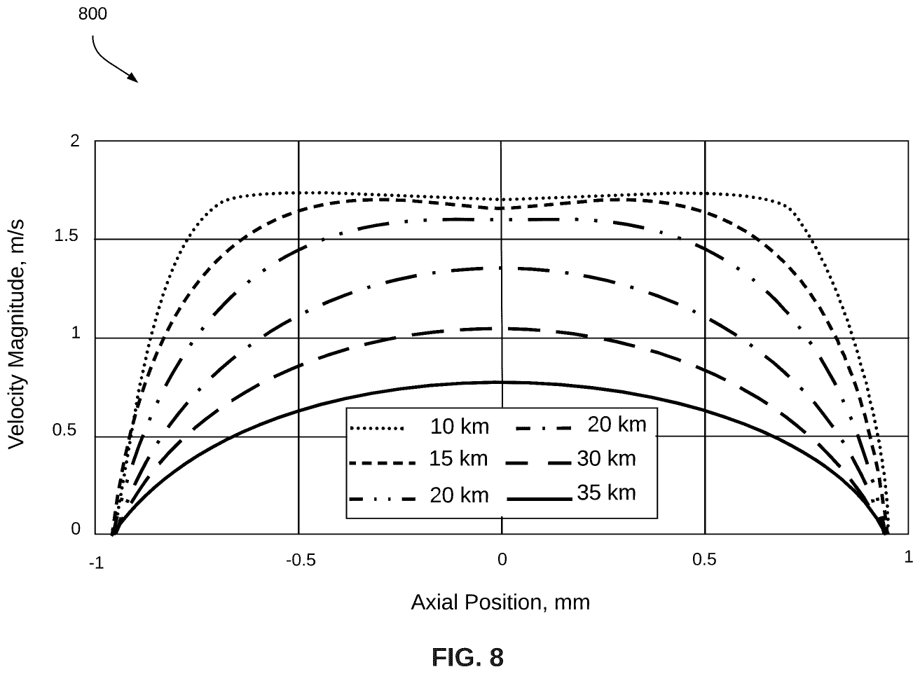

Exemplary simulations were run with velocities of 1-5 m/s and pressures and temperatures corresponding to altitudes ranging from 10 to 35 km in the US standard atmosphere, as noted in published literature in the references section. Solution data may be extracted along a line placed at a nominal wire location. The simulation results for the wire velocity profile at various altitudes are shown in FIG. 8 for a 2 m/s free-stream velocity. In particular, FIG. 8 includes a graph 800 showing CFD results for velocity magnitude along the wire at various altitude conditions. Results shown are for a simulated free-stream velocity of 2 m/s.

Simulation may be used to calculate the average velocity along the wire location, with a velocity correction factor defined as the ratio between the free-stream velocity (the velocity specified at the simulation inlet) and the average wire velocity:

$${f}_{cv} = \frac{{\overline{U}}_{w}}{{U}_{s}} \qquad [ Eq . 58 ]$$

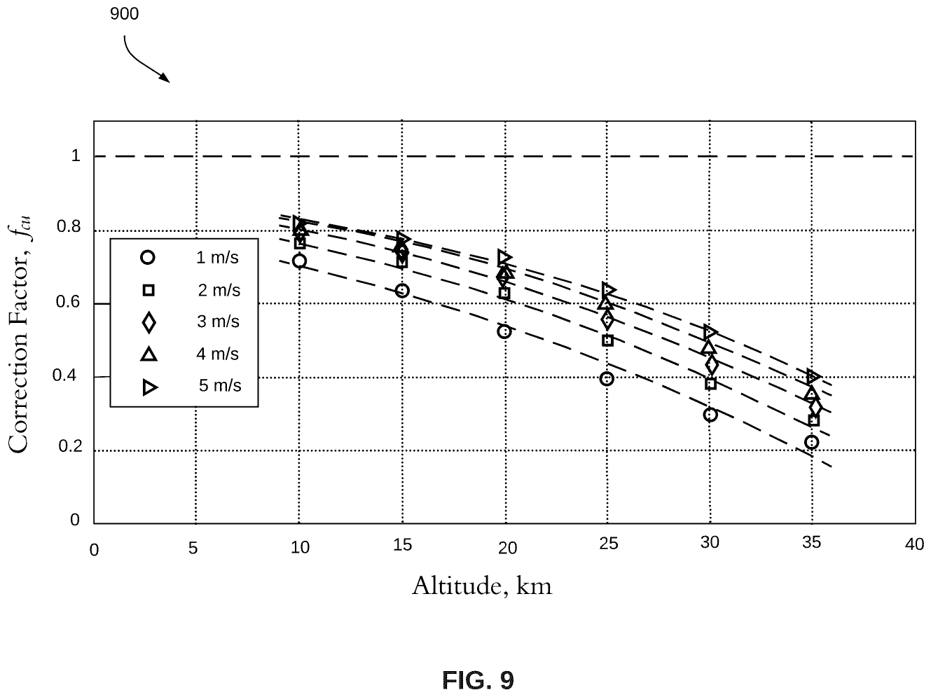

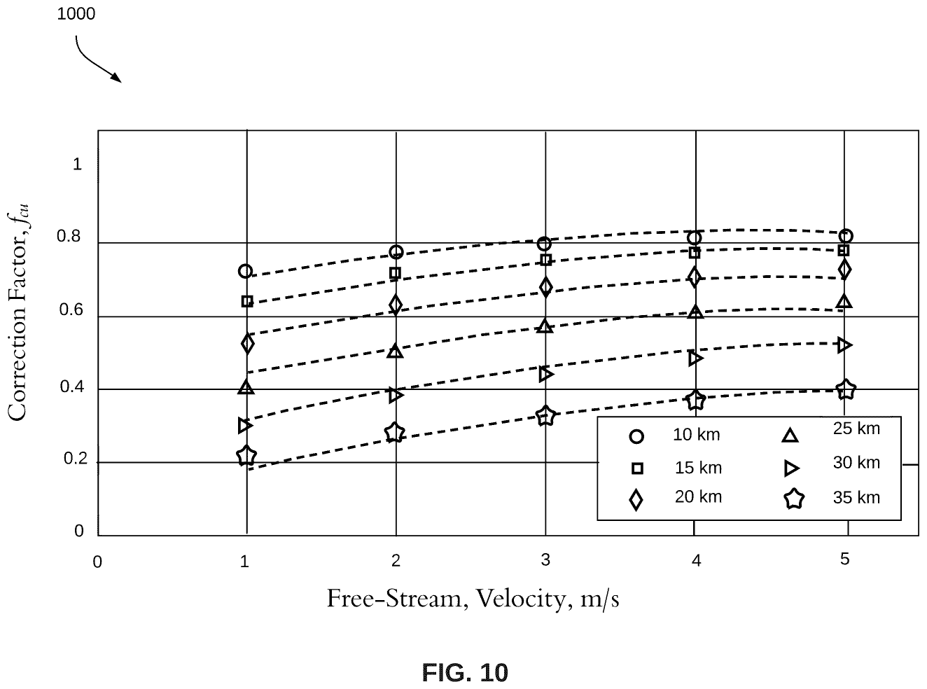

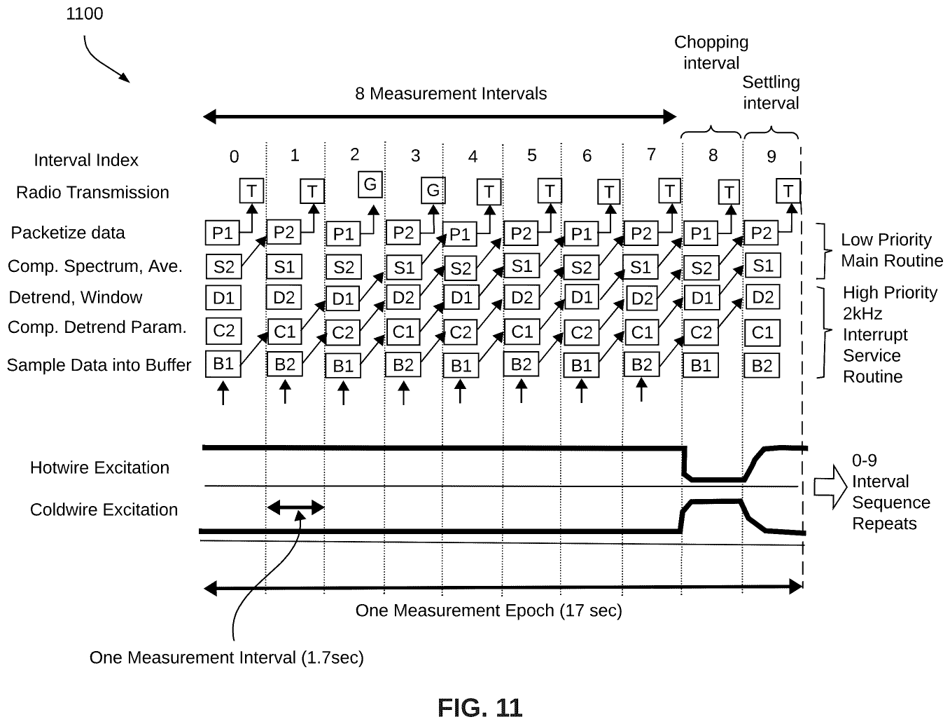

A value of f_{cv}=1 means that there is no blockage from the prongs and Uₛ=U_{w}. A two-dimensional, second order polynomial surface may be fit to the CFD results, with the form of an example fitting function given by:

$${f}_{cv} = A + {BU}_{s} + Ch + {DU}_{s} h + {EU}_{s}^{2} + {Fh}^{2} \qquad [ Eq . 59 ]$$

where h is altitude in km and coefficient values may be specified by the user (e.g., A=7.377E−1, B=7.724E−2, C=−8.064E−3, D=9.466E−4, E=−9.201E−3, and F=−3.058E−4 in the example illustrated in FIGS. 10 and 11). The simulation results may be used in a calibration procedure to convert from free-stream velocity (e.g., estimated from GPS vertical velocity data) to velocity at the wire. Simulation results for f_{cv} and the fitted model are shown as a function of altitude and velocity in FIGS. 9 and 10, respectively. In particular, FIG. 9 shows a graph 900 representing CFD results for velocity correction factor shown as a function of altitude. Dashed lines show the second order polynomial fit for each velocity case. Similarly, FIG. 10 shows a graph 1000 representing CFD results for velocity correction factor shown as a function of velocity. Dashed lines show the second order polynomial fit for each altitude case. These data may be used in the calibration procedure to convert from free-stream velocity (as estimated from filtered GPS vertical velocity data, discussed below) to velocity at the wire.

### Chopping Procedure

In some embodiments, the system may use a self-calibration procedure. In embodiments, the turbulent variations in fluid temperature and velocity may be measured and taken into consideration in the analog output from the overall system.

For instance, the self-calibration procedure may alternate excitation levels on the wire between a “normal” value and a “chopping” value once every 17 second epoch, where the normal excitation is used in the constituent 1.7 second intervals 0 through 7, as shown in FIG. 11.

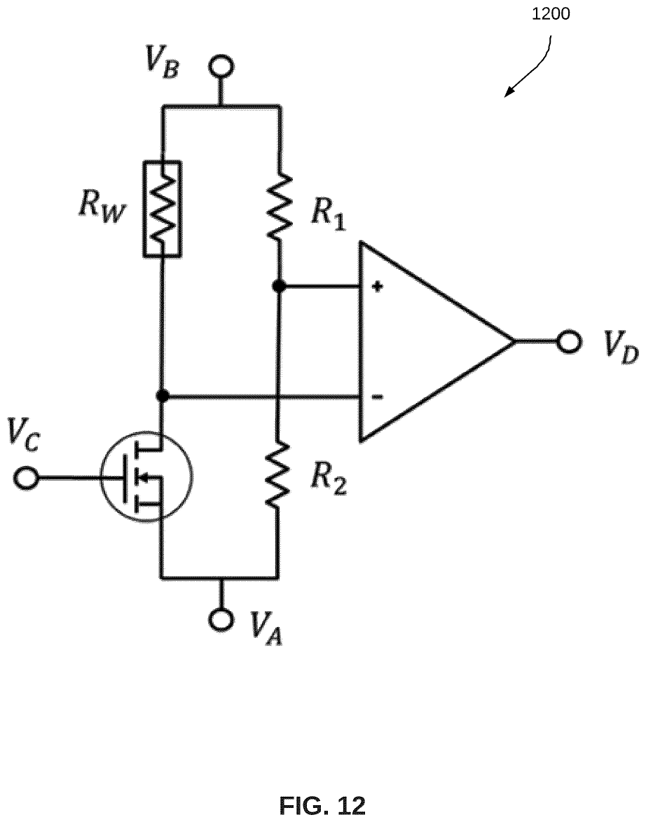

In the example timing scheme 1100 as shown in FIG. 11, the chopping interval is number 8. Interval 9 is a “settling interval” in preparation for regular measurements beginning in the next epoch with intervals 0-7. Turbulence measurements are not made during intervals 8 and 9. As illustrated in FIG. 12, fine-wire excitation may be periodically changed during the “chopping” interval (8) of each 17 second epoch, then returned to a “normal” value in interval 9 in preparation to repeat the cycle again starting with interval 0. Turbulence data is only acquired in intervals 0-7, resulting in turbulence telemetry packets (T) transmitted in intervals 0-1 and 4-9. For instance, the packets in intervals 2 and 3 may be “gondola” packets (G) containing average wire resistance and power data needed for the post-flight self-calibration procedure that is applied on each epoch. An exemplary processing pipeline is also shown, using alternating buffers (1 and 2) to ensure processing only occurs on data that is not being actively changed.

In an example, an objective of this self-calibration procedure may be to estimate the local average values of the bulk thermal conductance H, its radial fraction H_{R}, and the time averaged, mean wire temperature rise T̅_{w}−T̅ₐ.

For both hotwire and coldwire, let phase 1 of this procedure be the high-excitation case, resulting in measured average values V̅_{w1} and Ī_{w1} over 1.7 second intervals. Then we can compute P̅_{w1}=V̅_{w1}Ī_{w1} and R̅_{w1}=V̅_{w1}/Ī_{w1}. Assuming the average of dT̅_{w}(t)/dt over this interval is small, Eq. 43 may be rewritten as:

$${\overline{P}}_{w 1} = {\overline{H}}_{1} ( {\overline{\overline{T}}}_{w 1} - {\overline{T}}_{a} ) = {\overline{H}}_{1} {\overline{\overline{T}}}_{r 1} \qquad [ Eq . 60 ]$$

Phase 2 of this procedure is the low-excitation case, producing V̅_{w2}, Ī_{w2}, R̅_{w2}, and

$${\overline{P}}_{w 2} = {\overline{H}}_{2} ( {\overline{\overline{T}}}_{w 2} - {\overline{T}}_{a} ) = {\overline{H}}_{2} {\overline{\overline{T}}}_{r 2} \qquad [ Eq . 61 ]$$

We also have the resistance relationship between phases:

$${\overline{R}}_{w 1} = {\overline{R}}_{w 2} + α {R}_{wo} ( {\overline{\overline{T}}}_{w 1} - {\overline{\overline{T}}}_{w 2} ) = {\overline{R}}_{w 2} + α {R}_{wo} ( {\overline{\overline{T}}}_{r 1} - {\overline{\overline{T}}}_{r 2} ) \qquad [ Eq . 62 ]$$

These results create a non-linear system of three constraints and four unknowns, namely H̅₁, H̅₂, T̅ᵣ₁, T̅ᵣ₂).

A simple first-order self-calibration method assumes that the power difference is small and hence the wire temperature difference is small, adding the constraint that H̅₁=H̅₂=H̅ to reduce the number of unknowns to three. Then subtracting Eq. 61 from Eq. 60 results in

$${\overline{P}}_{\vert w 1} - {\overline{P}}_{w 2} = \overline{H} ( {\overline{\overline{T}}}_{r 1} - {\overline{\overline{T}}}_{r 2} ) \qquad [ Eq . 63 ]$$

And using Eq. 60, we have

$${\overline{P}}_{w 1} - {\overline{P}}_{w 2} = \overline{H} ( \frac{{\overline{R}}_{w 1} - {\overline{R}}_{w 2}}{α {R}_{wo}} ) \qquad [ Eq . 64 ]$$

which can be solved for the local average wire conductance H if R_{wo} is known. R_{wo} may be estimated from Eq. 7 using the relationship

$${R}_{wo} = {\overline{R}}_{w 2} / ( 1 + α ( {\overline{\overline{T}}}_{r 2} + {\overline{T}}_{a} - {T}_{o} ) ) \qquad [ Eq . 65 ]$$

where, if the phase 2 excitation is suitably low, as is the case for a coldwire temperature measurement, then the assumption T̅ᵣ₂+T̅ₐ≈T̅ₐ may be made. A separate instrument may be used to measure a local ambient temperature average T̅ₐ.

In turn, this relationship can be used in Eq. 60 to find the average temperature rise T̅ᵣ₁ for phase 1 and in Eq. 61 to find T̅ᵣ₂ for phase 2.

A second-order self-calibration method allows H̅₁ and H̅₂ to differ, and adds a different constraint, i.e., that:

$${\overline{H}}_{1} - {\overline{H}}_{2} = \frac{\partial H}{\partial T} ( {\overline{\overline{T}}}_{r 1} - {\overline{\overline{T}}}_{r 2} ) \qquad [ Eq . 66 ]$$

where ∂H/∂T is estimated based on local atmospheric conditions. In certain cases, ∂H/∂T may be specifically calculated using known methods. Here, a closed form solution may be available using the quadratic formula, and we may be able to more easily use iteration to converge to a solution starting with the first-order solution. Thus far, it has been found that the second order solution does not significantly improve the estimate for H, due to the relatively small change in temperature between phase 1 and phase 2, and given the weak sensitivity of H to film temperature.

With either the first or second order solution for the local H̅, we have the problem that H̅_{R} is also needed for the calibration in Eq. 49, not just H̅. Here we use the previous analytic solution for H̅_{A} to split out H̅_{R} from H̅. Using the steady state value in Eq. 38, we find:

$${\overline{η}}^{2} = \frac{( {\overline{H}}_{R}^{*} - α {\overline{I}}_{w}^{2} {R}_{wo} )}{{\overline{H}}_{A}^{*}} = \frac{( {\overline{H}}_{R}^{*} - \frac{α {\overline{P}}_{w 2}}{( 1 + α ( {\overline{T}}_{a} - {T}_{o} ) )} )}{{\overline{H}}_{A}^{*}} \qquad [ Eq . 67 ]$$

From Eq. 39, we obtain

$$\overline{H} = {\overline{H}}_{R} + {\overline{H}}_{A} = {\overline{H}}_{R}^{*} + {\overline{H}}_{A}^{*} {\overline{η}}^{2} ( \frac{2 tanh ( \overline{η} / 2 )}{\overline{η} - 2 tanh ( \overline{η} / 2 )} ) \qquad [ Eq . 68 ]$$

Here, \vec{H}_{A} can be estimated from wire properties alone (see Eq. 13), so that Eqs. 67 and 68 may be numerically solved for \vec{H}_{R}=H̅_{R}. In this way, the above derivations may be used in the calibration of measured voltages without requiring an external calibration reference.

### Measuring ΔH_{R}: Auto-Zero and Sensing Fine Wire Resistance Fluctuation

In both the hotwire and coldwire instruments, the fine wires may be connected in a Wheatstone bridge, an example of which is shown in FIG. 12. In particular, FIG. 12 shows a schematic of a Wheatstone bridge configuration 1200 with the resistance R_{w} corresponding to the fine wire located in the upper left leg and a field effect transistor (FET) forming the lower left leg of the bridge. The right leg of the Wheatstone bridge may include equal resistors R₁ and R₂ in the top and bottom of the leg.

Through feedback of the time integration and amplified signal difference in V_{D} to V_{C}, the FET keeps the bridge balanced at low frequencies such that the high frequency fluctuations remain centered within the operating voltage range of the high-gain amplifier stages that process the difference V_{D}, namely the difference between the mid-point voltage on the left and right side of the bridge, thus providing an implementation of the auto-zero property discussed above. In other words, through feedback of the time integration of amplified signal difference in V_{D} to V_{C}, the FET keeps the bridge balanced at low frequencies, such that the high frequency fluctuations are within the operating voltage range of the high-gain amplifier stages. This auto-zero feedback loop produces a high-pass characteristic on the fluctuations in R_{w}, such as caused by temperature and flow velocity variations, with a corner frequency of about 1 Hz. This corner frequency value is at the lower end of the frequency range used for spectral analysis in the extraction of turbulence parameters.

As an example, we may define a parameter R*_{w}=R_{FET} where, at low frequencies, R*_{w}=R_{w} or R̅_{w}=\vec{R}_{w}. Due to the limited frequency of bridge centering adjustment at V_{C}, variations in R_{w} above the centering corner frequency are not matched by R*_{W}, hence these variations may be amplified and subsequently processed to characterize turbulence.

This amplified bridge-difference signal V_{D} may also be fed back to the bridge excitation voltage V_{B}, causing power applied to the fine wire and, consequently, its temperature and resistance to change. This feedback provides a measure of temperature stabilization that rejects variations caused by ambient temperature and flow velocity, resulting in a so-called constant temperature (CT) wire excitation. It is recognized that, in real life systems, the temperature is never perfectly constant. The signal at V_{B} then may be considered to represent the fluctuations in wire heat transfer caused by the flow variations to be measured. This architecture also may increases the bandwidth of the wire's response to these disturbances, by an amount which depends on the gain of this feedback loop.

In other words, in such an implementation of the feedback system, the signal fed back to stabilize temperature reflects the ambient disturbances and may be used as the measurement of these disturbances. This architecture also increases the bandwidth of the wire's response to these disturbances by an amount depending on the gain of this feedback loop. This bandwidth increase can be important in high-altitude applications where the native wire bandwidth is small. In certain embodiments, the CT feedback may not be required on a coldwire version of the instrument, such that the wire excitation in this case a constant voltage (CV) arrangement. Such an implementation accommodates a more extreme non-linearity of the CT feedback in the coldwire case and higher attendant sensitivity to offset errors in the amplifiers, which may make the effective gain of this feedback system erratic for the coldwire case. In this implementation, the coldwire signal may exhibit a lower bandwidth than the hotwire.

It may be noted that, while CT feedback is commonly used with hot wire anemometers, it is not commonly used for coldwire thermometers, despite the potential bandwidth improvements. The hesitance to use the CT feedback with coldwire thermometers may be due to more extreme nonlinearity of the CT feedback in the coldwire case, as well as higher attendant sensitivity to offset errors in the amplifiers to make the effective gain of this feedback system erratic. In embodiments described herein, an active offset mitigation strategy is used to correct for these offset errors, enabling CT operation for the coldwire as well.

Since the turbulent fluctuations produce very small variations in fine wire resistance, a small-signal linearized analysis of the electronics may be used to model the frequency response of the circuit relating power fluctuations ΔP_{E} from Eq. 49 to the amplified and digitized output signal Vₒ₁. Using Laplace transforms, Eq. 49 can be written as:

$$Δ {P}_{E} ( s ) = Δ {P}_{w} ( s ) - ( \overline{H} + {sC}_{w} ) Δ {\overline{T}}_{w} ( s ) \qquad [ Eq . 69 ]$$

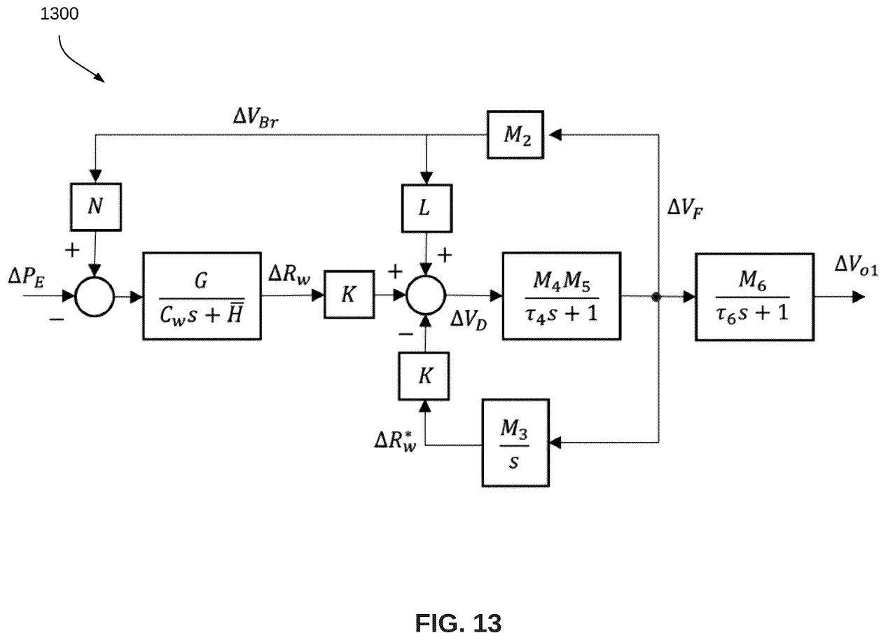

From analysis of a standard Wheatstone bridge circuit as exemplified in FIG. 13, the voltage drop across the wire may be expressed as:

$${V}_{w} ( s ) = \frac{{R}_{w} ( s )}{{R}_{w} ( s ) + {R}_{w}^{*} ( s )} {V}_{Br} ( s ) \qquad [ Eq . 70 ]$$

where VBr(s) is the Laplace transform of the bridge excitation voltage. Then, since P_{w}=V_{w}²/R_{w}, we have

$${P}_{w} ( s ) = \frac{{R}_{w} ( s )}{{( {R}_{w} ( s ) + {R}_{w}^{*} ( s ) )}^{2}} {V}_{Br}^{2} ( s ) \qquad [ Eq . 71 ]$$

Then first order deviations ΔP_{w}(s) are found as:

$$Δ {P}_{w} ( s ) = \frac{2 {\overline{R}}_{w}}{{( {\overline{R}}_{w} + {\overline{R}}_{w}^{*} )}^{2}} {\overline{V}}_{Br} Δ {V}_{Br} ( s ) + {\overline{V}}_{Br}^{2} \frac{{\overline{R}}_{w}^{*} - {\overline{R}}_{w}}{{( {\overline{R}}_{w}^{*} + {\overline{R}}_{w} )}^{3}} Δ {R}_{w} ( s ) - {\overline{V}}_{Br}^{2} \frac{2 {\overline{R}}_{w}}{{( {\overline{R}}_{w}^{*} + {\overline{R}}_{w} )}^{3}} Δ {R}_{w}^{*} ( s ) \qquad [ Eq . 72 ]$$

Due to the auto-zeroing feedback that keeps R̅_{w}=\vec{R}_{w} at low frequencies, the second term on the right reduces to zero and Eq. 72 simplifies to

$$Δ {P}_{w} ( s ) = \frac{{\overline{V}}_{Br}}{2 {\overline{R}}_{w}} Δ {V}_{Br} ( s ) - {( \frac{{\overline{V}}_{Br}}{2 {\overline{R}}_{w}} )}^{2} Δ {R}_{w}^{*} ( s ) \qquad [ Eq . 73 ]$$

It may be noted that Eq. 73 is independent of ΔR_{w}(s); that is, a small increase in R_{w} increases the voltage across R_{w} in the bridge circuit, while also decreasing the current through R_{w}, thus resulting in essentially no net change in wire power dissipation.

The fine-wire resistance Rw is related to deviations in wire temperature around T̅_{w} by

$${R}_{w} = {\overline{R}}_{w} + α {R}_{wo} ( {T}_{w} - {\overline{T}}_{w} ) ) = {\overline{R}}_{w} + Δ {R}_{w} \qquad [ Eq . 74 ]$$

$$where$$

$$Δ {R}_{w} = α {R}_{wo} Δ {T}_{w} \qquad [ Eq . 75 ]$$

Combining Eq. 73 and Eq. 69, we obtain

$$Δ {R}_{w} ( s ) = \frac{α {R}_{wo}}{( {C}_{w} s + \overline{H} )} ( \frac{{\overline{V}}_{Br}}{2 {\overline{R}}_{w}} Δ {V}_{Br} ( s ) - {( \frac{{\overline{V}}_{Br}}{2 {\overline{R}}_{w}} )}^{2} Δ {R}_{w}^{*} ( s ) - Δ {P}_{E} ( s ) ) \qquad [ Eq . 76 ]$$

thus showing that the deviation in wire resistance is a function of deviation in ambient conditions (through ΔP_{E}) as well as deviation in bridge excitation voltage ΔV_{Br}. The notation may be further simplified by defining:

$$G = α {R}_{wo} \qquad [ Eq . 77 ]$$

$$N = \frac{{\overline{V}}_{Br}}{2 {\overline{R}}_{w}} \qquad [ Eq . 78 ]$$

so that Eq. 76 becomes:

$$Δ {R}_{w} ( s ) = \frac{G}{( {C}_{w} s + \overline{H} )} ( N Δ {V}_{Br} ( s ) - {N}^{2} Δ {R}_{w}^{*} ( s ) - Δ {P}_{E} ( s ) ) \qquad [ Eq . 79 ]$$

The difference voltage V_{D} between the left and right sides of the bridge midpoints is given by:

$${V}_{D} = ( \frac{{R}_{2}}{{R}_{1} + {R}_{2}} - \frac{{R}_{w}^{*}}{{R}_{w}^{*} + {R}_{w}} ) {V}_{Br} \qquad [ Eq . 80 ]$$

In the situation where R₁=R₂,

$$Δ {V}_{D} ( s ) = [ \frac{1}{2} - \frac{{\overline{R}}_{w}^{*}}{{\overline{R}}_{w}^{*} + {\overline{R}}_{w}} ] Δ {V}_{Br} ( s ) + [ \frac{{\overline{V}}_{Br} {\overline{R}}_{w}^{*}}{{( {\overline{R}}_{w}^{*} + {\overline{R}}_{w} )}^{2}} ] Δ {R}_{w} ( s ) - [ \frac{{\overline{V}}_{Br} {\overline{R}}_{w}}{{( {\overline{R}}_{w}^{*} + {\overline{R}}_{w} )}^{2}} ] Δ {R}_{w}^{*} ( s ) \qquad [ Eq . 81 ]$$

$${=}^{def} L Δ {V}_{Br} ( s ) + K Δ {R}_{w} ( s ) - K Δ {R}_{w}^{*} ( s ) \qquad [ Eq . 82 ]$$

where L and K in Eq. 82 are defined as the corresponding bracketed coefficients in Eq. 81.

It may be noted that, if R̅_{w}=\vec{R}_{w}, then L=0 and K=V̅_{Br}/(4R̅_{w}) In practice, small offset errors in the amplifier stages can produce small bridge balance errors, and a non-zero value for L. This factor may produce another feedback loop that can affect the circuit gain, due to the large amplifier gain applied to L in this loop. While a potentially non-zero L may be retained in the analysis, this error causes a negligibly small error in K and, as was done for N above, we assume R̅_{w}=\vec{R}_{w} in the value given for K.

FIG. 13 shows an exemplary block diagram of an implementation of the instrument analog electronics 1300 for converting ambient power fluctuations ΔP_{E} to a voltage fluctuation ΔVₒ₁ that may be subsequently digitized, in accordance with an embodiment. As shown, the first amplifier stage may include a difference amplifier with voltage gain M₄ and a first-order low pass filter with a time constant of τ₄ sec. The second stage amplifier has a gain of M₅ and a very high bandwidth (not modeled here, with the assumption that the bandwidth of the second stage amplifier is much higher than the Nyquist rate of the signals to be analyzed). The offset in the first amplifier stage dominates the bridge balance error discussed above. This effect may be mitigated in flight by introducing a dither signal to the input of the second stage amplifier during the chopping interval (i.e., when the turbulence signals are not being sampled). The amplitude of this dither may be modulated by the loop gain of the bridge imbalance loop and, in turn, this effect reflects the degree of offset error. This amplified dither signal may be measured by the operations software of the turbulence measurement system, and a digital potentiometer may be used to adjust an applied offset to cancel the amplifier offset and achieve a uniform gain in this secondary feedback loop.

The output of the second stage is the voltage signal V_{F}. Thus,

$$Δ {V}_{F} ( s ) = \frac{{M}_{4} {M}_{5}}{( {τ}_{4} s + 1 )} Δ {V}_{D} ( s ) \qquad [ Eq . 83 ]$$

The voltage deviation ΔV_{F} is fed back to the bridge excitation through a third amplifier with a gain M₂ so that we find:

$${ΔV}_{Br} ( s ) = - {M}_{2} Δ {V}_{F} ( s ) \qquad [ Eq . 84 ]$$

The voltage ΔV_{F} is also fed back through an integrating amplifier to the gate of the FET, causing the lower leg of the bridge resistance to deviate from nominal via the expression:

$$Δ {R}_{w}^{*} ( s ) = \frac{{M}_{3}}{s} Δ {V}_{F} ( s ) \qquad [ Eq . 85 ]$$

This feedback loop provides the auto-zero function by causing the average resistance \vec{R}_{w} to change until V̅_{F}=0, allowing the instrument to accommodate a wide range of initial wire resistances, and to accommodate the change in a given wire resistance with the large change in ambient temperature that occurs as the balloon ascends from the ground to over 30 kilometers in altitude.

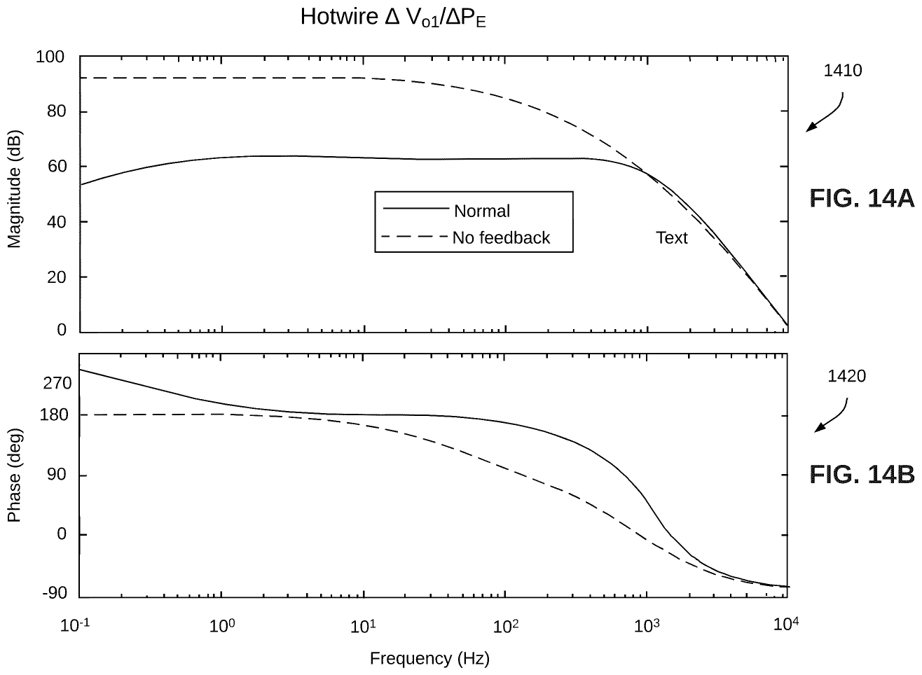

The circuit model, according to the exemplary embodiment shown in FIG. 14, may be completed by adding a final amplifier stage to produce the output signal Vₒ₁ with gain M₆ and an anti-alias filter (e.g., for subsequent digital sampling) with a time constant τ₆ to provide:

$$Δ {V}_{o 1} ( s ) = \frac{- {M}_{6}}{( {τ}_{6} s + 1 )} {ΔV}_{F} ( s ) \qquad [ Eq . 86 ]$$

The closed loop transfer function from ΔP_{E} to ΔVₒ₁ can then be computed:

$$\frac{Δ {V}_{o 1} ( s )}{Δ {P}_{E} ( s )} = {W}_{( s )} = \frac{{M}_{6}}{( {τ}_{6} s + 1 )} \frac{sKG {M}_{4} {M}_{5}}{\begin{matrix}( {C}_{w} s + \overline{H} ) ( s ( ( {τ}_{4} s + 1 ) + L {M}_{2} {M}_{4} {M}_{5} ) + \\ {KM}_{3} {M}_{4} {M}_{5} ) + KGN {M}_{4} {M}_{5} ( {sM}_{2} + {NM}_{3} )\end{matrix}} \qquad [ Eq . 83 ]$$

Exemplary values for these parameters are given in Table 1 for the hotwire and coldwire, in accordance with an embodiment.

TABLE 1
Exemplary values for parameters for hotwire and coldwire analog
electronics boards, in accordance with an embodiment.

| Parameter | Hotwire | Coldwire |
|---|---|---|
| N, [A] | 0.130/R̅_{w} | 0.020/R̅_{w} |
| K, [A] | 0.065/R̅_{w} | 0.010/R̅_{w} |
| G, [Ohm/K] | αR̅_{w} | αR̅_{w} |
| L | −1.2 × 10⁻⁴ to 1.9 × 10⁻⁴ | −7.4 × 10⁻⁴ to 12 × 10⁻⁴ |
| M₂ | −1.00 | 0 |
| M₃, [1/sec] | 34.2 | 15.7 |
| M₄ | 40.68 | 40.68 |
| M₅ | 5.022 | 10.05 |
| M₆ | −20.80 | −199.0 |
| τ₄, [sec] | 2.0 × 10⁻⁴ | 2.0 × 10⁻⁴ |
| τ₆, [sec] | 2.0 × 10⁻⁴ | 2.0 × 10⁻⁴ |

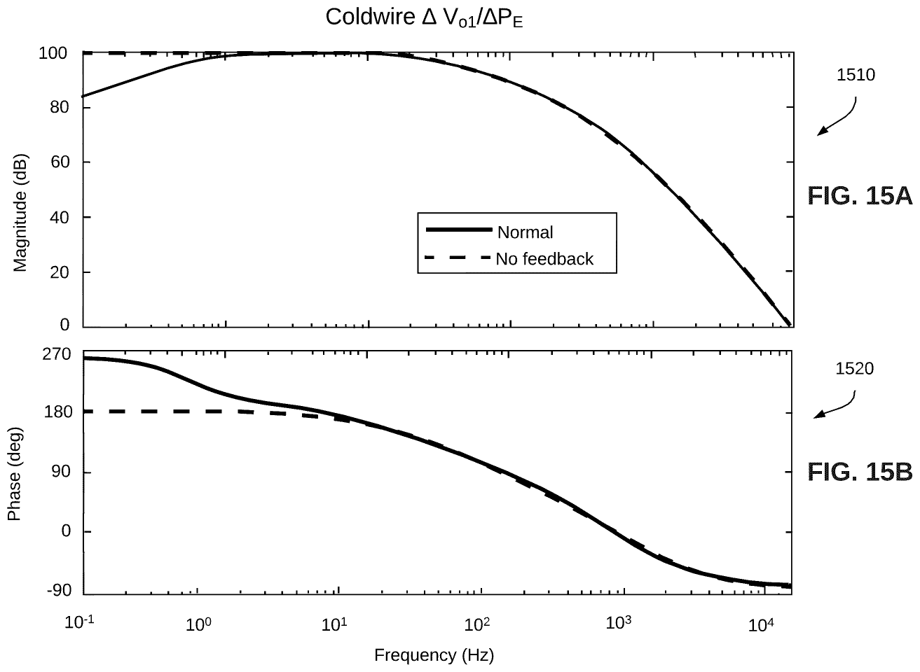

Given these models for the electronics frequency response, measured signals at ΔVₒ₁ may be passed through the inverse of the frequency response to recover the signal ΔP_{E}. This process may also be performed for the power spectral density, rather than the frequency response signals, in an embodiment. Using the values in Table 1, and Rw and H typical for conditions at 30 km altitude, we get the frequency response shown in FIGS. 14A and 14B for the hotwire instrument, and in FIGS. 15A and 15B for the coldwire instrument. In particular, FIGS. 14A and 14B show graphs 1410 and 1420 of typical hotwire instrument frequency response in terms of the magnitude and phase, respectively, as a function of frequency, in accordance with embodiments. Similarly, FIGS. 15A and 15B are graphs 1510 and 1520 of typical coldwire instrument frequency response in terms of the magnitude and phase, respectively, as a function of frequency, in accordance with embodiments.

Note the coldwire case illustrated in FIGS. 15A and 15B has a high pass corner frequency at about 1 Hz and begins to roll off at high frequencies at about 60 Hz. This would be the case with the hotwire, except that the CT feedback has pushed these two corner frequencies apart, resulting in a high pass corner at about 0.2 Hz and a low pass corner at about 1 kHz. Note that this feedback has also reduced the gain in the passband considerably.

Given these models for the electronics frequency response, measured signals at ΔVₒ₁ can be passed through the inverse of the frequency response to recover the signal ΔP_{E}. This process may be performed for the power spectral density, rather than the time domain signals, as discussed later.

Since the transfer function W(s) depends on H̅ and R̅_{w}, which are both functions of altitude, W(s) should be re-computed periodically to keep up with these relatively slow changes as the balloon descends from apogee. Values for these parameters are available from the turbulence measurement system self-calibration “chopping” procedure discussed above, updated once each 17 second epoch. In offline final calibration these produce a different W(s) for each epoch, which is inverted to determine the power spectrum of ΔP_{E} from the power spectrum of ΔVₒ₁ for the eight measurement intervals in each epoch.

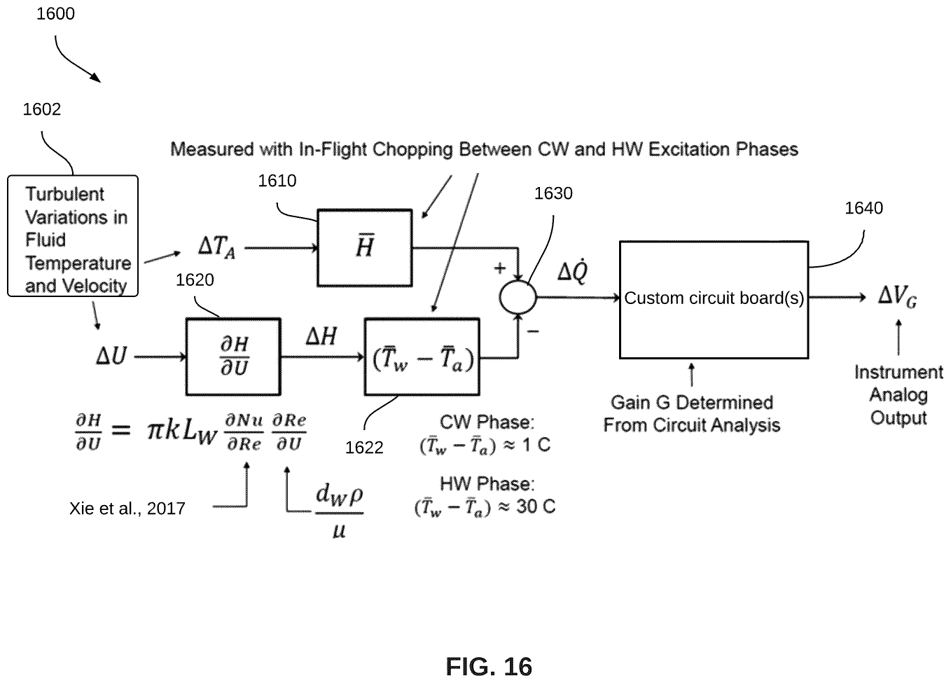

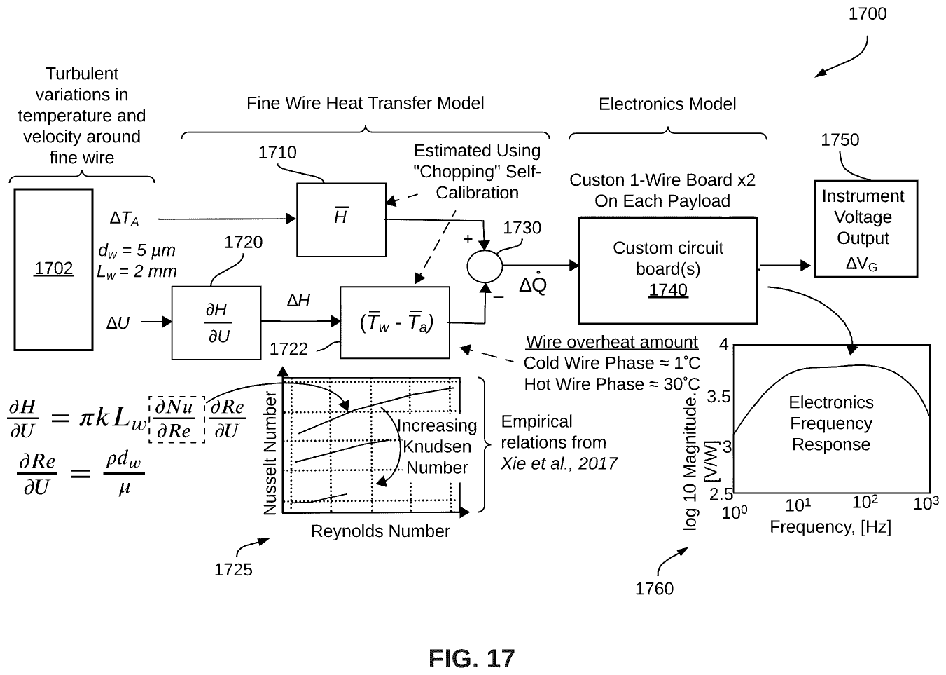

Two possible embodiments of the self-calibration using the derivations above are shown in FIGS. 16 and 17 below. As shown in FIG. 16, an exemplary self-calibration process 1600 begins with detection 1602 of any turbulent variations in temperature (ΔTₐ) and velocity (ΔU) around the fine wires, in certain embodiments. The temperature and velocity fluctuations may be evaluated using the fine wire heat transfer/small signal model detailed above while simultaneously implementing an in-flight chopping scheme between the coldwire and hotwire excitation phases, as described above. For instance, temperature variation ΔTₐ may be used to derive values for average thermal conductance in a step 1610. A change in thermal conduction H as a function of the velocity variation ΔU may be analyzed in a step 1620 to derive the thermal conduction variation ΔH, which is fed into a step 1722 to evaluate a wire temperature profile using, for example, empirical relationships described in Xie et al., 2017, referenced below.

The results of the analysis of the temperature and velocity variations may be combined in a step 1630 then further processed through an electronics model on one or more custom circuit boards 1640. It is noted that the analysis may also take place on a processor, rather than electronics. Circuit boards 1640 may then be used to generate an instrument analog output ΔV_{G} 1650 indicative of the atmospheric turbulence so detected.

As shown in FIG. 17, another illustration of a self-calibration process 1700 also begins with detection 1702 of any turbulent variations in temperature (ΔTₐ) and velocity (ΔU) around the fine wires, in certain embodiments. Assumptions may be made regarding the fine wire dimensions, such as a diameter of 5 microns and a length of 2 millimeters, as shown in FIG. 17.

The temperature and velocity fluctuations may be evaluated using the fine wire heat transfer/small signal model detailed above. For example, temperature variation (ΔTₐ) may be used to derive values for average thermal conductance in a step 1710, including estimation using the chopping self-calibration process outlined above. Similarly, the change in thermal conduction H as a function of the velocity variation ΔU (i.e., the derivative of H over U) may be analyzed in a step 1720 to derive the thermal conduction variation ΔH, which in turn may be used to evaluate a wire temperature profile in a step 1722. In examples, steps 1720 and 1722 may involve an iteration of calculations of the Nusselt number as a function of Reynolds number as shown in graph 1725 (the specific empirical relations between the various parameters may be found, for example, in Xie et al., 2017, referenced below).

The results of the analysis of the temperature and velocity variations may be combined in a step 1730 then further processed through an electronics model on one or more custom circuit boards 1740. Again, the analysis may also take place digitally on a processor, rather than through analog electronics. Circuit boards 1740 may then produce a data stream such as an instrument voltage output ΔV_{G} and/or a frequency response, which may then be used to characterize the atmospheric turbulence so detected.

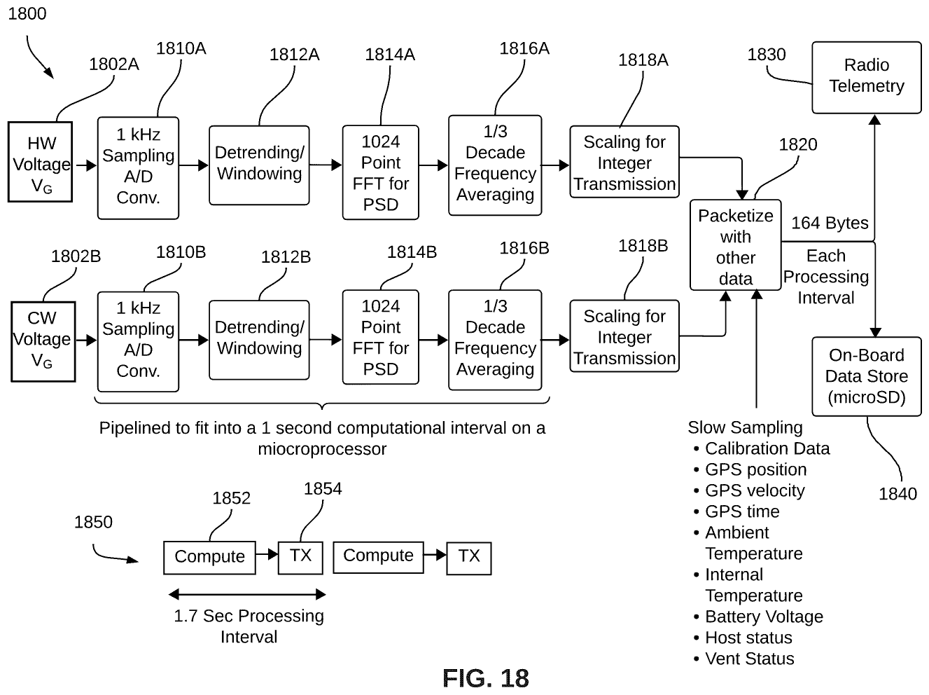

Further, the system described herein may be implemented with low cost, low power microcontrollers suitable for disposable payloads by using a pipelined software architecture, which enables a heretofore unseen, compact process flow for the in-flight processing of measured data. An example implementation of a software pipeline 1800 is shown in FIG. 18.

As illustrated in the example shown in FIG. 18, voltage signals 1802A and 1802B from the hotwire and coldwire instruments, respectively, may be processed separately through a variety of processing steps. The processing steps may include, for example analog-to-digital conversion 1810A and 1810B, detrending and/or windowing process 1812A and 1812B, Fast Fourier Transform 1814A and 1814B, frequency averaging 1816A and 1816B, and scaling 1818A and 1818B. In embodiments, some of the processing steps for each pipeline (i.e., hotwire or coldwire) may be pipelined to fit into a one-second computational interval on a commercial microcontroller to reduce cost (e.g., a TEENSY® Development Board by PJRC).

The resulting data from both the hotwire and coldwire pipelines may be packetized with other data in a step 1820. In examples, each processing interval may result in a 164-byte packet of data, which then may be transmitted using, for example, radio telemetry 1830 and/or stored onboard the measurement system, such as on a microSD card 1840.

As shown in FIG. 18, a processing flow such as flow 1850 may include a compute step 1852 followed by a transmit step 1854 in a pre-defined processing interval, such as 1.7 seconds as shown in FIG. 18. Compute and transmit steps 1852 and 1854 may then be repeated. In embodiments, cached data may be cleared after each transmit step or at predefined intervals in order to minimize the required onboard data storage capacity.

### Estimation of Turbulence Parameters

The following lays out an exemplary procedure for calculating turbulent kinetic energy dissipation rate ϵ, and the turbulent temperature structure parameter C_{T}². These are both based on fitting a spectral model for turbulence to power spectral density (PSD) data obtained from 1.024 second data records of the measured hotwire or coldwire instrument voltage ΔVₒ₁. This PSD data is then averaged over 8 fractional-decade frequency bins and telemetered to the ground. In post-flight processing this data is calibrated to a flow velocity PSD and fit to inertial sub-range models to extract the turbulent kinetic energy dissipation rate ϵ for each of the 1.024 second intervals captured in flight.

### A. On-Board Processing

On board the balloon payload, instrument voltage ΔVₒ₁ is digitized to 16-bit resolution at a sampling rate of 1.0 kHz in data records V_{S}(k) that are N=1024 samples k long. These records are then de-trended by least squares fitting of a first-order polynomial in time and subtracting this from the data record to produce V_{SD}(k). Next, this de-trended data is multiplied by a Hanning window function that is amplitude-adjusted to preserve variance in the de-trended signal to produce V_{SDW}. The Fast-Fourier-Transform (FFT) is then applied to V_{SDW}:

$${\begin{matrix}{\hat{V}}_{SDW} ( n ) = \frac{2}{N} {\sum }_{k = 0}^{N - 1} {V}_{SDW} ( k ) {e}^{( - 2 i π kn / N )} , 0 \leq n \leq N - 1 & [ Eq . 88 ]\end{matrix}}_{}$$

The 2/N factor normalizes the FFT so that sinusoidal components up to the Nyquist frequency (assuming the conjugate symmetric components above the Nyquist frequency) produce the correct sinusoidal component amplitudes in the time signal. The power spectral density (PSD) may then obtained by:

$${S}_{V} ( n ) = \frac{{t}_{s}}{2} {\vert {\hat{V}}_{SDW} ( n ) \vert}^{2} \qquad [ Eq . 89 ]$$

where tₛ is the length of the sampling interval in seconds. The units of S_{V} are V²/Hz (for the hotwire) and K²/Hz for the coldwire. The frequencies corresponding to the index n of SV may be expressed as:

$$f ( n ) = \frac{n}{{Nt}_{s}} , [ Hz ] 0 \leq n \leq N - 1. \qquad [ Eq . 90 ]$$

However, the normalization on S_{V} is such that the average power P_{V} in V_{SDW}(k) on the interval of 0≤k≤N−1 samples is given by the sum of only the components up to the Nyquist rate f_{N}=(N/2−1)/(Ntₛ), times the frequency interval Δf=1/(Ntₛ):

$${P}_{V} = \frac{1}{N} {\sum }_{k = 0}^{N - 1} {V}_{SDW}^{2} ( k ) = \frac{1}{{Nt}_{s}} {\sum }_{n = 0}^{N / 2 - 1} {S}_{V} ( n ) . \qquad [ Eq . 91 ]$$

As this power spectral density (PSD) data will be fit with a smooth model (detailed below), the details of individual PSD values are not important, so the PSD may be averaged over fractional-decade frequency intervals, and these averages are telemetered to the ground station. Since there are 512 PSD values up to the Nyquist rate, and there are only 8 averaging intervals, this process provides a data compression factor of 64. These averaging intervals each cover successive powers of 2 in frequency (i.e., 0.3 decade). FIG. 12 shows an exemplary embodiment in which these computations are organized in two alternating pipelines in the on-board microprocessor, for each of the hotwire and coldwire signals.

### B. Post-Flight Ground Processing

A model for the turbulence cascade of the velocity PSD in the inertial subrange and into the viscous subrange may be expressed as:

$${S}_{U} ( f ) = β \frac{{f}^{- 5 / 3}}{{( 1 + {( f / {f}_{0} )}^{8 / 3} )}^{2}} \qquad [ Eq . 92 ]$$

where S_{U} is the PSD of velocity fluctuations, and fₒ is the frequency corresponding to the inner scale that separates the inertial subrange from the viscous subrange, where the f^{-5/3} slope rolls off further to a f⁻⁷ slope. Note there are other models for the transition region between the inertial and viscous sub-ranges, producing slightly different roll-off characteristics. In the present case, the inertial subrange portion of the PSD is the region of interest, and much of the viscous region is not visible above the noise floor, so the details of this roll-off are not considered to be important. However, the beginning of a roll-off is often seen in the PSD data, and fitting a curve of this form helps reduce the fit error in the inertial sub-range compared to fitting a straight line to data that has a “knee.” There are two parameters in this fitted function: the overall height of the curve β and the corner frequency fo where the knee in the curve occurs. These parameters are found by converting the fit function into a linear-in-the-parameters form and applying a least-squares algorithm to minimize the fit error with the spectral data as follows.

First, the voltage PSD S_{V} is converted to a PSD of velocity fluctuation S_{U}. This step is required due to the electronics gain W(s) relating electrical power ΔPE(s) to the measured voltage Vₒ₁(s) developed earlier and from the sensitivity of ΔP_{E}(s) to velocity fluctuations ΔU_{w}(s), also developed earlier:

$$Δ {U}_{w} ( s ) = {( \frac{\partial {H}_{R}}{\partial {U}_{w}} )}^{- 1} Δ {H}_{R \cdot } = {( \frac{\partial {H}_{R}}{\partial {U}_{w}} {\overline{\overline{T}}}_{r} )}^{- 1} Δ {P}_{E} = {( \frac{\partial {H}_{R}}{\partial {U}_{w}} {\overline{\overline{T}}}_{r} W ( s ) )}^{- 1} Δ {V}_{o 1} ( s ) \qquad [ Eq . 93 ]$$

$$where$$

$$\frac{\partial {H}_{R}}{\partial {U}_{w}} = \frac{π {kL}_{w} ρ {d}_{w}}{μ} ( \frac{\partial Nu}{\partial Re} {\vert}_{\overline{Re}} ) \qquad [ Eq . 94 ]$$

Section V above related to Calculation of Velocity Fluctuations outlined the procedure for calculating this value. The PSD relations may then be expressed as:

$${S}_{U} ( f ) = {\vert \frac{\partial {H}_{R}}{\partial {U}_{w}} {\overline{\overline{T}}}_{r} W ( i 2 π f \vert}^{- 2} {S}_{V} ( f ) \qquad [ Eq . 95 ]$$

The parameters in the turbulence model of Eq. 92 may be estimated by first frequency-weighting S_{U}(f) by multiplying by f^{5/3}.

$${S}_{UW} ( f ) = \frac{β}{{( 1 + {( f / {f}_{o} )}^{8 / 3} )}^{2}} \qquad [ Eq . 96 ]$$

Taking the inverse square root of Eq. 92, the relationship may be reformulated in a linear equation form:

$${( {S}_{UW} ( f ) )}^{- 1 / 2} = \frac{1 + {( f / {f}_{o} )}^{8 / 3}}{{( β )}^{1 / 2}} = {θ}_{1} + {θ}_{2} {f}^{8 / 3} \qquad [ Eq . 97 ]$$

Eq. 97 may then be rewritten in a matrix form for the parameters θ₁=β^{-1/2} and θ₂=fₒ^{-8/3}:

$$\hat{y} ( f ) = [ 1 {f}^{8 / 3} ] [ \begin{matrix}{θ}_{1} \\ {θ}_{2}\end{matrix} ] = {x ( f )}^{T} θ \qquad [ Eq . 98 ]$$

Each frequency bin center f may be stacked vertically into a vector:

$$θ = {( {XX}^{T} )}^{- 1} XY \qquad [ Eq . 100 ]$$

$$\text{where:}$$

$$β = {θ}_{1}^{- 2} \qquad [ Eq . 101 ]$$

$${f}_{o} = {( {θ}_{1} / {θ}_{2} )}^{3 / 8} \qquad [ Eq . 102 ]$$

Then, the parameter vector θ that minimizes the error between Ŷ and the vector Y of measured values of (S_{UW}(f))^{-1/2} is found from

$$\hat{Y} = {X}^{T} θ \qquad [ Eq . 99 ]$$

From the literature, it is recognized that the parameter β of the velocity PSD S_{U}(f) is related to the dissipation rate ϵ by the expression:

$$ϵ = {( \frac{β}{0.146169} )}^{3 / 2} \frac{1}{{\overline{U}}_{S}} \qquad [ Eq . 103 ]$$

where Ū_{S} is the mean free stream velocity of the ambient air relative to the hotwire during the measurement interval.

The value for Ū_{S} may be obtained from filtered GPS data, for example, by assuming the airspeed Ū_{S} of the sensor through a parcel of air should be locally constant even while the turbulence measurement system may be moving vertically with respect to the ground, e.g., due to gravity wave activity. It is recognized herein that the average of the GPS velocity over a typical gravity wave (buoyancy) period should then provide a reasonable estimate of the descent rate through the parcel. Since the turbulence data is taken during the balloon descent, the gondola suspended below the balloon is typically quiescent, with very little pendulation. This effect contrasts with the ascent, where wake shedding by the balloon may cause large pendulation amplitudes. Nevertheless, instances of strong wind shear during the descent can induce pendulation, with lateral velocities relative to the descent rate that are significant. To capture this effect in the relative velocity Ū_{S}, GPS horizontal velocity may be sampled, for example, at 5 Hz and amplitude detected over 100 sample intervals to estimate the root mean square (RMS) horizontal velocity, that is telemetered to the ground in the gondola packets every 17 sec epoch. This horizontal velocity may be vectorially combined with the vertical velocity to produce an estimate of the magnitude of the relative wind Ū_{S} on each epoch.

For temperature fluctuations, the measured voltage is converted to temperature via the electronics gain W(s) relating electrical power ΔP_{E}(s) to the measured voltage Vₒ₁(s) developed earlier for the coldwire and from the sensitivity of ΔP_{E}(s) to temperature fluctuations ΔT_{w}(s) developed in Eq. 49:

$$Δ {T}_{w} ( s ) = \frac{1}{{\overline{H}}_{R}} Δ {P}_{E} = \frac{1}{{\overline{H}}_{R}} \frac{1}{W ( s )} Δ {V}_{o 1} ( s ) \qquad [ Eq . 104 ]$$

The relation between voltage PSD and temperature PSD may then be expressed as:

$${S}_{T} ( f ) = {\vert \frac{1}{{\overline{H}}_{R}} \frac{1}{W ( s )} \vert}^{2} {S}_{V} ( f ) \qquad [ Eq . 105 ]$$

The turbulent temperature structure parameter C_{T}² may be found in a similar way from the PSD of temperature variations measured by the coldwire. The spectral model may be expressed as:

$${S}_{T} ( f ) = \frac{{f}^{- 5 / 3}}{{( 1 + {( f / {f}_{o} )}^{8 / 3} )}^{2}} \qquad [ Eq . 106 ]$$

This expression may be fit to the frequency averaged PSD data, telemetered from the payload, for example by using a least squares procedure as described, above to estimate the intensity parameter γ and the corner frequency fₒ. Using information available in the literature, the temperature structure parameter may then be expressed as:

$${C}_{T}^{2} = ( \frac{γ}{0.073084} ) \frac{1}{{\overline{U}}_{\text{?}}^{2 / 3}} \qquad [ Eq . 107 ]$$

$$\text{?} \text{indicates text missing or illegible when filed}$$

### IX. Error Analysis

The above estimates for ϵ and C_{T}² are based Eq. 49 with specific assumptions, namely: 1) ambient temperature variations ΔTₐ have a small effect on wire power measurements ΔP_{E} relative to the effect of velocity variations ΔU for hotwire signals; and 2) flow velocity variations ΔU have a small effect on wire power measurements ΔP_{E} relative to the ambient temperature variations ΔTₐ for the coldwire signals.

For the hotwire, with a mean wire temperature rise T̅_{rH} over ambient, the Laplace transform relationship from Eq. 49 may be used to derive:

$$Δ {P}_{EH} ( s ) = \frac{\partial {H}_{R}}{\partial {U}_{w}} {\overline{\overline{T}}}_{rH} Δ {U}_{w} ( s ) + {\overline{H}}_{R} Δ {T}_{a} ( s ) = a Δ {U}_{w} ( s ) + b Δ {T}_{a} ( s ) \qquad [ Eq . 108 ]$$

where the second term is ignored in the extraction of the power spectral density ΔU_{W} from power spectral density ΔP_{EH} in the estimation of ϵ. Similarly, for the coldwire with mean wire temperature rise T̅_{rC} over ambient, which is typically much smaller than T̅_{rH}, the following relationship may be derived:

$$Δ {P}_{EC} ( s ) = \frac{\partial {H}_{R}}{\partial {U}_{w}} {\overline{\overline{T}}}_{rC} Δ {U}_{w} ( s ) + {\overline{H}}_{R} Δ {T}_{a} ( s ) = c Δ {U}_{w} ( s ) + b Δ {T}_{a} ( s ) \qquad [ Eq . 109 ]$$

Here, the first term was ignored in the extraction of the power spectral density of Tₐ from the power spectral density of ΔP_{EC} in the estimation of C_{T}².

It is noted that the hotwire and coldwire are mounted within 2 cm of each other at the tip of the sensing probe in a co-located sensing arrangement. Further, in embodiments, these sensing wires are fabricated to have similar geometry. Then, Eqs. 108 and 109 may be used together to solve for the spectral variations in both ΔU_{w} and ΔTₐ from measurements of ΔP_{EH} (from the hotwire) and ΔP_{EC} (from the coldwire) by inverting the matrix relation embodied therein, specifically:

$$[ \begin{matrix}Δ {U}_{w}^{*} ( s ) \\ Δ {T}_{a}^{*} ( s )\end{matrix} ] = [ \begin{matrix}\frac{1}{a - c} & \frac{- 1}{a - c} \\ \frac{- c}{( a - c ) b} & \frac{a}{( a - c ) b}\end{matrix} ] [ \begin{matrix}Δ {P}_{EH} ( s ) \\ Δ {P}_{EC} ( s )\end{matrix} ] \qquad [ Eq . 110 ]$$

These “full” solutions may be compared to the “diagonal” solutions used in estimating ϵ and C_{T}² described above, namely:

$$[ \begin{matrix}Δ {U}_{w} ( s ) \\ Δ {T}_{a} ( s )\end{matrix} ] = [ \begin{matrix}\frac{1}{a} & 0 \\ 0 & \frac{1}{b}\end{matrix} ] [ \begin{matrix}Δ {P}_{EH} ( s ) \\ Δ {P}_{EC} ( s )\end{matrix} ] \qquad [ Eq . 111 ]$$

Accordingly, the following normalized error bounds may be derived:

$$\vert \frac{Δ {U}_{w}^{*} ( s ) - Δ {U}_{w} ( s )}{Δ {U}_{w} ( s )} \vert \leq \vert \frac{c}{a - c} \vert + \vert \frac{a}{a - c} \vert \vert \frac{Δ {P}_{EC} ( s )}{Δ {P}_{EH} ( s )} \vert \qquad [ Eq . 112 ]$$

$$\vert \frac{Δ {T}_{a}^{*} ( s ) - Δ {T}_{a} ( s )}{Δ {T}_{a} ( s )} \vert \leq \vert \frac{c}{a - c} \vert + \vert \frac{c}{a - c} \vert \vert \frac{Δ {P}_{EH} ( s )}{Δ {P}_{EC} ( s )} \vert \qquad [ Eq . 113 ]$$

It may be noted that

$$\frac{c}{a - c} = \frac{{\overline{\overline{T}}}_{rC}}{{\overline{\overline{T}}}_{rH} - {\overline{\overline{T}}}_{rC}} ; \frac{a}{a - c} = \frac{{\overline{\overline{T}}}_{rH}}{{\overline{\overline{T}}}_{rH} - {\overline{\overline{T}}}_{rC}} \qquad [ Eq . 114 ]$$

hence the spectral errors in ΔU_{w} and ΔTₐ may be bounded by expressions involving the temperature rise in the sensor wires and the ratio of the electrical power fluctuations in the sensor wires. Typical operating conditions have the first terms in Eqs. 112 and 113 to approximately equal 0.03, making the error bounds primarily dependent on the second terms, i.e., dependent on the wire electrical power fluctuation ratio between hotwire and coldwire. In embodiments, the measurements telemetered to the ground may provide information on the PSDs of these fluctuations averaged over frequency intervals centered at eight distinct frequencies. The resulting errors in the PSDs of velocity and temperature can then be bounded by the following at each frequency f:

$$\frac{{S}_{Uerr} ( f )}{{S}_{U} ( f )} = {\vert \frac{Δ {U}_{w}^{*} ( i 2 π f ) - Δ {U}_{w} ( i 2 π f )}{Δ {U}_{w} ( i 2 π f )} \vert}^{2} \leq {( \vert \frac{c}{a - c} \vert + \vert \frac{a}{a - c} \vert \sqrt{\frac{{S}_{{P}_{EC} ( f )}}{{S}_{{P}_{EH} ( f )}}} )}^{2} \qquad [ Eq . 115 ]$$

$$\frac{{S}_{Uerr} ( f )}{{S}_{T} ( f )} = {\vert \frac{Δ {T}_{a}^{*} ( i 2 π f ) - Δ {T}_{a} ( i 2 π f )}{Δ {T}_{a} ( i 2 π f )} \vert}^{2} \leq {( \vert \frac{c}{a - c} \vert + \vert \frac{c}{a - c} \vert \sqrt{\frac{{S}_{{P}_{EH} ( f )}}{{S}_{{P}_{EC} ( f )}}} )}^{2} \qquad [ Eq . 116 ]$$

During post-flight calibration, estimates of ϵ and C_{T}² may be flagged as unreliable by noting which corresponding normalized PSD errors are above a desired threshold, such as 0.1.

It is also notable that a wire power ratio S_{P}_{_{EH}}(f)/S_{P}_{_{EC}}(f) that improves one error bound tends to make the other error bound worse due to the inverse dependence on this ratio between the two bounds. However, if the overheat T̅_{rH} on the hotwire is increased, both a and ΔP_{EH} will increase proportionally, presuming that the first term in Eq. 108 already dominates. This dependency causes the spectral power error of Eq. 115 to decrease according the inverse square, although the second term in Eq. 116 does not accordingly decrease. This error can be reduced by decreasing the overheat T̅_{rC} on the coldwire, which causes a proportional decrease in c, and ΔP_{EC} is not significantly affected, assuming that the second term in Eq. 109 already dominates. In this case, Eq. 116 decreases according to the square.

Another factor to consider is the reduction of ∂H_{R}/∂U_{w} with altitude, which reduces both a and c. On the other hand, at the same wire voltage excitation, the temperature rises in both hotwire and coldwire increase with altitude. It may be advantageous to vary the wire excitation with altitude to maintain a reasonable values of both a and c.

In summary, the present disclosure describes various embodiments of a turbulence measurement system including hotwire anemometers and coldwire thermometers advantageously calibrated by comparison to reference sensors operated at the conditions of interest.

For example, in the case of turbulence measurements in the stratosphere, on-board reference sensors are generally not available. While anticipated stratospheric conditions may be replicated with special purpose wind tunnels, pre-calibration of all fine-wire sensing elements over the range of pressures and temperatures and flows to be encountered would be cost-prohibitive. Instead, the present disclosure details a system and an associated method for post-flight calibration utilizing a combination of self-calibration data generated in flight using a “chopping” procedure, along with models of the heat transfer from the fine wires. The heat transfer model may be derived from first-principles and CFD studies, as described above, along with models of the electronics used to process the fine-wire heat transfer fluctuations.

Since the radial heat transfer from the fine-wires is small under rarefied conditions, axial heat conduction to the supporting prongs may be significant, even for wires with a large L/D aspect ratio. This characteristic may be accounted for using an analytic solution to the 1-D linearized heat equation for this situation, enabling the axial thermal conductance to be quantified relative to the radial conductance, such that the radial fluctuations that relate to flow velocity over the wire may be retrieved. Comparison with the nonlinear PDE numerical solution shows that this analytic linearized solution provides bulk thermal conductance within 4% over the altitude ranges of interest.

This procedure also takes account of the disturbance of the flow around the supporting prongs using CFD simulations, resulting in simple empirical models that enable the velocity inferred at the wire to be referred to the free stream.

Flow and temperature fluctuations result in electrical power fluctuations in the fine wires that may be measured, amplified, and digitized by electronics. The relation between the measured wire power and flow velocity depends on the sensitivity of radial thermal conductance to flow speed and on the average temperature rise of the hotwire. The former may be computed using known properties of air at ambient temperature and pressure and known properties of the fine wire. The latter is a by-product of the chopping procedure that alternates wire excitation between hotwire and coldwire levels. The chopping procedure also enables direct measurement of the mean radial conductance needed to relate temperature changes to wire power fluctuations in the coldwire.

Wire power fluctuations may be processed by the analog electronics front end to result in voltage signals that are digitized and telemetered to the ground for post-flight calibration and conversion to turbulence parameterizations. The signal gain and frequency response of these electronics are modeled in detail, allowing an inverse processing algorithm to convert voltages to wire power, and in turn, to measurements of flow velocity and temperature fluctuations to complete the instrument calibration. The analog front end may be configured to provide an auto-zero capability that enables high resolution measurements over a wide range of fine wire resistance changes due to the wide ambient temperature variation in flight and due to variations in manufacturing of the low-cost wire elements. The analog front end may also provide software control of auto-zero speed, circuit gain, amplifier offsets, and wire excitation levels to implement the chopping procedure and reduce the effects of RF telemetry interference with the turbulence measurements.

Turbulence parameterizations may be computed in post-flight analysis from spectral data generated on-board. This spectral data may be averaged in fractional-decade frequency intervals to enable long distance data transmission due to a data compression factor of 64. The data compression may be an important capability because it facilitates the telemetric downloading data, thus obviating the need for balloon chasing and physical recovery of the payload data and greatly reducing the costs of acquiring data in the stratosphere. Similarly, the custom electronics in the payload may be low-cost enough to be expendable while still providing sufficient sensitivity.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The terms and expressions employed herein are used as terms and expressions of description and not of limitation, and there is no intention, in the use of such terms and expressions, of excluding any equivalents of the features shown and described or portions thereof. Each of the various elements disclosed herein may be achieved in a variety of manners. This disclosure should be understood to encompass each such variation, be it a variation of an embodiment of any apparatus embodiment, a method or process embodiment, or even merely a variation of any element of these. Particularly, it should be understood that the words for each element may be expressed by equivalent apparatus terms or method terms-even if only the function or result is the same. Such equivalent, broader, or even more generic terms should be considered to be encompassed in the description of each element or action. Such terms can be substituted where desired to make explicit the implicitly broad coverage to which this invention is entitled.

As but one example, it should be understood that all action may be expressed as a means for taking that action or as an element which causes that action. Similarly, each physical element disclosed should be understood to encompass a disclosure of the action which that physical element facilitates. Regarding this last aspect, by way of example only, the disclosure of a “protrusion” should be understood to encompass disclosure of the act of “protruding”—whether explicitly discussed or not—and, conversely, were there only disclosure of the act of “protruding”, such a disclosure should be understood to encompass disclosure of a “protrusion”. Such changes and alternative terms are to be understood to be explicitly included in the description.

### REFERENCES

Bruun, H. H., Hot-Wire Anemometry: Principles and Signal Analysis, Oxford University Press, 1995. URL https://www.ebook.de/de/product/3604315/h_h_bruun_hot_wire_anemometry_principles_and_signal_analysis.html.
Frehlich, R., Mellier, Y., Jensen, M., and Balseley, B., “Turbulence Measurements with the CIRES Tethered Lifting System during CASES-99: Calibration and Spectral Analysis of Temperature and Velocity,” J. Atmospheric Sciences, Vol. 60, 2003, pp. 2487-2495.
Fritts, D. C., “Gravity wave dynamics and effects in the middle atmosphere,” Reviews of Geophysics, Vol. 41, No. 1, 2003. https://doi.org/10.1029/2001rg000106.
Kolmogorov, A. N., “A refinement of previous hypotheses concerning the local structure of turbulence in a viscous incompressible fluid at high Reynolds number,” Journal of Fluid Mechanics, Vol. 13, No. 1, 1962, pp. 82-85. https://doi.org/10.1017/s0022112062000518.
Mahon, A., Pointer, J., Lawrence, D., and Argow, B., “A calibration system for low-velocity flows at stratospheric conditions,” Proc. AIAA Scitech 2020 Forum, 2020.
NASA, “U.S. Standard Atmosphere,” Tech. Rep. NASA-TM-X-74335, National Aeronautics and Space Administration, October 1976.
Prabhu, K. M. M., Windowing Functions and their Applications in Signal Processing, CRC Press, 2014.
Rondeau, C. M., and Jorris, T. R., “X-51A Scramjet demonstrator program: Waverider ground and flight test,” SFTE 44th International/SETP Southwest Flight Test Symposium, Ft. Worth, T X, 2013.
Roseman, et al., “Experimental and Numerical Calibration of Hotwire Anemometers for the Study of Stratospheric Turbulence,” AIAA SciTech 2021 FORUM, published online 2021 Jan. 4.
Roseman, et al., “A Low-Cost Balloon System for High-Cadence, In-Situ Stratospheric Turbulence Measurements,” AIAA AVIATION 2021 FORUM, published online 2021 Jul. 28.
Xie, F., Li, Y., Liu, Z., Wang, X., and Wang, L., “A forced convection heat transfer correlation of rarefied gases cross-flowing over a circular cylinder,” Experimental Thermal and Fluid Science, Vol. 80, 2017, pp. 327-336. https://doi.org/10.1016/j.expthermflusci.2016.09.002.

1. A system for measurement of turbulence in the atmosphere, the system comprising:
a hotwire sensor;
a coldwire sensor; and
a gondola containing electronics including a microprocessor,
wherein the gondola includes a first surface,
wherein the gondola further includes a support structure protruding from the first surface, the support structure being configured for supporting the hotwire sensor and the cold wire sensor at a fixed orientation with respect to each other, and
wherein the electronics are configured to implement a self-calibration procedure.

2. The system of claim 1 further comprising telemetry antennas.

3. The system of claim 1, wherein the hotwire sensor is a turbulence anemometer.

4. The system of claim 3, wherein the coldwire sensor is a turbulence thermometer.

5. The system of claim 3, further comprising a balloon for transporting the hotwire sensor, the coldwire sensor, and the gondola into a desired altitude.

6. A system for fine-scale, in-situ measurements of turbulence in the atmosphere, the system comprising:
a balloon-borne instrument, the balloon-borne instrument including:
a hotwire anemometer;
a coldwire thermometer;
a gondola containing electronics;
a support structure affixed to the gondola for supporting the hotwire anemometer and the coldwire thermometer at a fixed distance from the gondola; and
a balloon for transporting the gondola to a desired altitude,
wherein the hotwire anemometer and the coldwire thermometer are configured for performing measurements during descent from the desired altitude to generate measurement data,
wherein the electronics includes circuitry for analyzing the measurement data during flight to produce analyzed data and transmitting the analyzed data to a ground station remotely located from the system, and
wherein the electronics are further configured for self-calibrating the analyzed data according to the measurement data.
